(19) United States
(12) Patent Application Publication
(10) Pub. No.: US 2020/0402081 A1
(43) Pub. Date: Dec. 24, 2020

(54) METHOD OF SELECTING QUESTIONS FOR RESPONDENTS IN A RESPONDENT-INTERROGATOR SYSTEM

(71) Applicant: SQN Innovation Hub AG, Zurich (CH)

(72) Inventors: Adam VOTAVA, Zurich (CH); Per LAGERSTROM, Buchillon (CH); Kathryn FORGAN, Buchillon (CH)

(73) Assignee: SQN Innovation Hub AG, Zurich (CH)

(21) Appl. No.: 16/909,636

(22) Filed: Jun. 23, 2020

(30) Foreign Application Priority Data
Jun. 24, 2019 (EP) PCT/EP2019/066723

(51) Int. Cl. G06Q 30/02; G06F 16/9032; G06F 16/9536

(52) U.S. Cl. CPC G06Q 30/0203; G06F 16/9536; G06F 16/90332

(57) ABSTRACT

A method of querying respondents of one or more population(s) of potential respondents with regard to one or more construct(s), with an interrogator that is configured to transmit question signals to any respondent, and to receive answer signals from the respondents in response to the questions signals, the method comprising one or more surveys. Each survey comprising at least one twisit of a querying cycle comprising the following steps running concurrently: (a) A question selection step in which the interrogator selects one or more question(s) for each of one or more respondent(s) to be interrogated in the twisit, each question being assigned at least one of the plurality of constructs, (b) An interrogation step in which the interrogator sends question signal(s) comprising the question(s) to the one or more respondent(s), and (c) A response step in which the interrogator receives answer signal(s) from those respondent(s) that are responsive to the interrogator's question signal(s). In at least one of the surveys in at least one of the survey's twisits, at least part the respondent(s) are queried at least twice in the same twisit in that after the interrogator, in step (c), has received answer signal(s) from a respondent of the part of the respondent(s), the interrogator, in concurrent step (a), selects one or more new question(s) for the same respondent, and in concurrent step (b), the interrogator sends question signal(s) comprising the new question(s) to the same respondent.

### FIELD OF THE INVENTION

The invention concerns a method of querying respondents from one or more population(s) of potential respondents of potential respondents. It also concerns an interrogator being configured to perform such method. Moreover, the invention concerns a computer program product comprising a computer readable storage medium that stores computer useable program code executable by a processor, the executable computer useable program code comprising code to perform such method. Further, the invention concerns a method for gathering evaluation information from a user with a computer network and a computer network for gathering evaluation information for at least one predetermined characteristic from at least one user.

### BACKGROUND OF THE INVENTION

From the patent application publication US 2019 0066136 A1 methods for generating conversational survey questions is known. The Methods analyse a received survey question response to identify characteristics of a survey response, including topics and other response features. For example, the systems can determine a sentiment associated with a given product or service that a respondent expresses within a response. Based on the determined sentiment, and further based on a set of logic rules received from a survey administrator, the methods generate conversational follow-up questions associated with the identified product or service.

The patent application publication US 20190164182 A1 relates to collecting and analysing electronic survey responses that include user-composed text. In particular, methods are disclosed that facilitate collection of electronic survey responses in response to electronic survey questions. The classify the electronic survey questions and determine a semantics model including customized operators for analysing the electronic survey responses to the corresponding electronic survey questions. In addition, the methods provide a presentation of the results of the analysis of the electronic survey responses via a graphical user interface of a client device.

From patent application publication US 20080091510 A1 methods for surveying a target population are provided. A survey instrument is fielded to a sample population of the target population, where individual members in the sample population are selected from the target population such that the distribution of members in the sample that start the survey instrument provides a probability sampling of the target population for at least one stratification variable. A qualifying population is identified from the sample, where each member in the qualifying population qualifies for the survey instrument based on a response to one or more screener questions in the survey instrument. A total number of members is determined within the target population that the qualifying population represents based on a comparison of the distribution of the qualifying population and the distribution of the target population with respect to the at least one stratification variable.

The U.S. Pat. No. 10,387,786 B2 discloses situational awareness and communication system that receives a request for situational awareness information from a requesting device associated with a requester. The situational awareness request includes a geographic area of interest and one or more of a demographic profile of interest and a topical area of interest. The system also receives real-time geographic location data reported by mobile communication devices associated with potential respondents and one or more of demographic data and topical area of interest data reported by the communication devices or obtained from social media files associated with the potential respondents located within the geographic area of interest. The system provides the situational awareness information to the requesting device including demographic statistics for potential respondents located within the geographic area of interest.

### OBJECT OF THE INVENTION

It is an object of the present invention to provide an improved method of querying respondents from one or more population(s) of potential respondents. It is another object of the present invention to provide an interrogator being configured to perform such improved method. Moreover, the invention aims at providing a computer program product comprising a computer readable storage medium that stores computer useable program code executable by a processor, the executable computer useable program code comprising code to perform the improved method. The invention further seeks to provide an improved a method for gathering evaluation information from a user with a computer network and an improved computer network for gathering evaluation information for at least one predetermined characteristic from at least one user.

### Solution According to the Invention

In the following, any reference to one (including the articles “a” and “the”), two or another number of objects is, provided nothing else is expressly mentioned, meant to be understood as not excluding the presence of further such objects in the invention. The reference numerals in the patent claims are not meant to be limiting but merely serve to improve readability of the claims.

In one aspect of the invention, the problem is solved by a method of querying respondents of one or more population(s) of potential respondents with regard to one or more construct(s) according to claim 1. An interrogator that is configured to transmit question signals (210) to any respondent, and to receive answer signals from the respondents in response to the questions signals. The method comprising one or more surveys, and each survey comprising at least one twisit of a querying cycle comprising the following steps running concurrently:
(a) A question selection step in which the interrogator selects one or more question(s) for each of one or more respondent(s) to be interrogated in the twisit, each question being assigned to at least one of the plurality of constructs,
(b) An interrogation step in which the interrogator sends question signal(s) comprising the question(s) to the one or more respondent(s), and
(c) A response step in which the interrogator receives answer signals from those respondent(s) that are responsive to the interrogator's question signal(s).

At least part the respondent(s) are queried at least twice in the same twisit in that after the interrogator, in step (c), has received answer signal(s) from a respondent of the part of the respondent(s), the interrogator, in concurrent step (a), selects one or more new question(s) for the same respondent, and in concurrent step (b), the interrogator sends question signal(s) comprising the new question(s) to the same respondent.

In the context of the present invention, the terms “plurality”, “several” and “multiple” are used synonymously and mean “one or more”. “At least one of the x's” with regard to something “x” that can also be present only once is meant as shorthand for “the x or at least one of the x's”. For example, “at least one of the surveys” means “the survey or at least one of the surveys.”

An “interrogator” is any device or combination of devices that can communicate with the respondents in order to exchange signals. The invention also includes embodiments that comprise more than one interrogator. The interrogator typically is a computer, for example a server in a computer network, or a combination of computers, that run(s) a computer program executing a method according to the invention.

A “potential respondent” in any entity that can communicate with the interrogator to exchange signals. Potential respondents can for example include a sensor device, such as weather sensor device that can measure temperature or amounts of precipitation or a medical sensor that can measure physiological parameters of its wearer, or a “thing” of an Internet of Things. It can also be a device comprising a human-computer-interface for outputting information to and receiving information from a human user. In particular, potential respondents can be personal profiles of a human or animal respondents, each in combination with a device comprising a human-computer interface which behaves according to the profile. Respondents can even be animals or humans as long as the animals or humans each are capable of receiving question signals from the interrogator and sending answer signals to the interrogator. A “population of potential respondents” are the several potential respondents as a whole.

A “respondent” is a “potential respondent” that has been selected in the respondent selection step to be sent question signals by the interrogator. Each respondent is sent one or more questions signals, and the respondent can send one or more answer signals in response, typically one answer signal in response to each question signal; ie, typically, the interrogator can receive one answer signal for each question signal sent, provided that the respondent is responsive. Typically, each question signal contains information, namely a “question”, which the respondent considers in creating the answer signal. For instance, the question signal can be a SOAP or electronic mail message, or output on a computer screen. Likewise, each answer signal can be for instance a SOAP or electronic mail message, text input via a keyboard, sound, in particular spoken words recorded by a microphone, or video recorded by a camera. The question can for example be “What is the temperature in degrees centigrade?”, “What is the amount of precipitation in millimetres?” or “What is the level of enthusiasm in your organisation on a scale from 1 to 10?”. Also typically, the answer signal contains information, namely an “answer”. The answers to the above questions can for example be “18”, “10” and “7”.

In the context of the present invention, a “question” can be a single question, or it can be a set of constituent questions that together form the question. For example, in the case of a weather sensor device, a set of constituent questions may be “Are you equipped with a precipitation sensor?”, “If so, have you detected rain within the past 24 hours?” and “If so, “what is the amount of precipitation in millimetres?”. Similarly, if the respondent is a member of a human organisation or obtains its answers from a member of a human organisation, a set of constituent questions may be “Think about a significant day at your organisation when you felt enthusiastic. What happened that day?” and “What were you thinking when it happened?”

Each question is assigned to at least one “construct”. Typically, there are several constructs, and a question can be assigned to one or more of the constructs. Preferably, a construct refers to a conclusion to which the questions which are assigned to the construct contribute. For example, if the respondent is a weather sensor device, questions that contribute to a conclusion about the apparent temperature can be assigned to the construct “apparent temperature”; Such questions can, for example, include “what is the air temperature?”, “what is the relative humidity” and “what is the wind speed?” Similarly, if the respondent is a member of a human organisation or obtains its answers from a member of a human organisation, questions such as “on a scale of 1 to 10, how willing are you to stand up for your organisation?” and “on a scale of 1 to 10, how willing are you to stand up for your superior?” can be assigned to the construct “advocacy”.

There can be only one population, all potential respondents being part of this population, or there can be several populations of potential respondents. In the latter case, each potential respondent is assigned to at least one of several “cells”, and all potential participants that share one such cell form the population of this cell. Preferably, the cells represent an intrinsic characteristic of the respondent, ie, an information that does not result from the interaction of the interrogator and the recipient, for example its location (such as “Switzerland” or “South Africa”) or its task area (such as “sales” or “research and development”, or “temperature” or “precipitation”). It may also be a combination of such intrinsic characteristics, for example the combination of location and task area. Preferably, the potential participants are divided into populations that are mutually exclusive, preferably by assigning each potential respondent to only one cell. Yet, the invention also comprises embodiments in which at least some of the populations overlap, preferably by assigning at least some participants to more than one cell. For example, some participants may be assigned the cell “Switzerland” and the cell “Zurich” and others the cell “Switzerland and the cell “Bern”.

With “those recipients that are responsive” it is meant to clarify that the answer signal is in response to the question signal, ie prompted by the questions signal, and that not all or even none of the question signals may not result in an answer signals. The latter may be due to respondents not receiving the questions signals, for example out of network problems, and as a result may not send answer signals. Moreover, some or all of the respondents may not provide an answer signal even if they receive a question signal, for example due to a lack of energy or because it is unable to create an answer to the question. Also, even if a respondent sends an answer signal, this may not reach the interrogator, for example out of network problems.

A “twisit” is an iteration of the query cycle. The word can be understood as an acronym that stand for “The way I see it”. The terms “twisit” and “query cycle” are not meant to imply that one twisit must have been completed before the next twisit is started. Rather, an overlap of twisits is allowable. In particular, it may happen that an answer signal in response to a question signal sent to a respondent in an earlier twisit is received by the interrogator only while a later twisit has already started. This later twisit can be of the same survey or even of a later survey. Such overlap can for example be caused by delays in the communication between interrogator and respondents or by a time the respondent needs to create an answer signal in response to the question signal.

Similarly, the term “step” is not meant to imply that one step must have been completed before the next step is started. For example, it may happen that answer signals are received in the response step while question signals are still sent to respondents in the interrogation step. Similarly, in the question selection step not all questions need to be selected at once. Rather, according to the invention at first only some questions may be selected in the question selection step and sent to one or more respondents in the interrogation step; and information about the answers received in response to these questions can then be used in the selection of more questions in the continuation of the question selection step in the same twisit.

It is an achievable advantage of this aspect of the invention that by questioning a respondent several times in the same twisit, more relevant information can be obtained. From the respondent. For example, with the first question the interrogator may be prompted to make a certain category of data available, and in the second question specific data from this category can be retrieved. In particular, as is explained in more detail below, it is possible with the invention that the subsequent question(s) are selected based on the respondent's answer to the first question, thereby greatly increasing the efficiency of communication.

In another aspect of the invention, the problem is solved by an interrogator according to claim 14. The interrogator is configured to transmit question signals with regard to one or more constructs to any respondent selected from a population of potential respondents, and to receive answer signals from the respondents in response to the questions signals The interrogator is configured to perform the above method.

In a further aspect of the invention, the problem is solved by a computer program product according to claim 17. The computer program product comprising a computer readable storage medium that stores computer useable program code executable by a processor, the executable computer useable program code comprising code to perform the above method.

In another aspect of the invention, the problem is solved by an interrogator according to claim 14. The interrogator is configured to transmit question signals with regard to one or more constructs to any respondent selected from a population of potential respondents, and to receive answer signals from the respondents in response to the questions signals The interrogator is configured to perform the above method.

In a further aspect of the invention, the problem is solved by a computer program product according to claim 17. The computer program product comprising a computer readable storage medium that stores computer useable program code executable by a processor, the executable computer useable program code comprising code to perform the above method.

In yet another aspect of the invention, the problem is solved by a method for gathering evaluation information from a user with a computer network according to claim 18. The computer network performs the following:
Receiving an initial set of predetermined response tasks each response task including a number of predetermined response options, wherein based on the response options selected by a user, evaluation information for evaluating at least one predetermined characteristic can be determined;
Outputting, via a computer device of said computer network, at least one free-formulation response task to at least one user by means of which an at least partially freely formulated response can be received from the user;
Identifying, via a computer device of said computer network, evaluation information based on the freely formulated response, said evaluation information being usable for evaluating the at least one predetermined characteristic;
Generating, via a computer device of said computer network, an adjusted set of response tasks based on the identified evaluation information.

In a final aspect of the invention, the problem is solved by a computer network for gathering evaluation information for at least one predetermined characteristic from at least one user according to claim 19. The computer network has an initial set of predetermined response tasks, each response task comprising a number of predetermined response options, wherein based on the response options selected by a user, evaluation information for evaluating at least one predetermined characteristic can be determined; and wherein the computer network comprises at least one processing unit that is configured to execute any of the following software modules, stored in a data storage unit of the computer network:
A free-formulation output software module that is configured to provide at least one free-formulation response task by means of which a freely formulated response can be received from at least one user;
A free-formulation analysis software module that is configured to analyse the freely formulated response and to thereby identify evaluation information contained therein, said evaluation information being usable for evaluating the at least one predetermined characteristic;

A response set adjusting software module that is configured generate an adjusted set of response tasks based on the evaluation information identified by the free-formulation analysis software module.

### Preferred Embodiments of the Invention

Preferred features of the invention which may be applied alone or in combination are discussed in the following and in the dependent claims.

A preferred survey according to the invention comprises more than one twisit, for example two, three four or five twisits. Preferably, the number of twisits is 20 or less, more preferably 10 or less.

Dynamic Branching

In a preferred embodiment of the invention survey according to the invention in at least one of the surveys—preferably in all surveys—in at least one—preferably in all—of the survey's twisits, at least part the respondent(s) are queried at least twice in the same twisit, more preferably three times in the same twisit, preferably at least four time, more preferably at least 5 time, more preferably at least 6 times. Each time after the interrogator, in step (c), has received answer signals from a respondent of the part of the respondent(s) in response to first question(s), the interrogator, in concurrent step (a), selects one or more new question(s) for the same respondent, and in concurrent step (b), the interrogator sends question signal(s) comprising the new question(s) to the same respondent, and this may be repeated the appropriate number of times.

For example, in at least one of the surveys—preferably in all surveys—in at least one —preferably in all—of the survey's twisits, in the question selection step the interrogator selects first question(s) for each of one or more respondents to be interrogated in the twisit, in the interrogation step the interrogator sends first question signal(s) comprising the first question(s) to the one or more respondent(s), and in the response step the interrogator receives first answer signal(s) from those respondent(s) that are responsive to the interrogator's first set of question signal(s). Then, preferably, in the same twisit's question selection step the interrogator selects second question(s) for each of one or more respondents to be interrogated in the twisit, wherein the interrogator in the selection of the second question(s) uses information about the first answer signal(s). In other words, the question selection step does not end after the selection of the first questions(s) but continues. The interrogation and response steps, likewise, can be continued with a second question signal(s) comprising the second question(s) and in the response step can be continued with second answer signal(s) from those respondent(s) that are responsive to the interrogator's second question signal(s). The process can be continued with third, fourth, fifth and even further question(s), question signal(s) and answer signal(s). Preferably, the interrogator in the selection of the thirds, fourth, fifth and further question(s) uses information about all previous answer signal(s) of the same twisit.

Preferably, if a recipient that has been queried before is queried again in the same twisit, the interrogator in the selection of the one or more question(s) for the respondent uses information about the answer signals which the interrogator has received previously from the same respondent, more preferably in the same twisit. Advantageously, with this embodiment of the invention, the interrogator in the subsequent queries can ask more relevant questions. As a result, the ratio of relevant information obtained to the amount of interaction between interrogator and respondent can be increased, thereby increasing the effectiveness of the query method. For example, in the first question the interrogator can ask the respondent what type of device it is. If it responds that it is a precipitation sensor device, it can then ask specific questions about precipitation and avoid questions that cannot be answered by the respondent, such as, for example, questions about temperature. Similarly, when the recipient in the answer to an earlier question reports something that raises the interrogator's interest, it can, in a later question attempt to elucidate more details. For example, the interrogator can ask an open ended question such as “what of relevance happened within the past 24 hours?”, thereby leaving the evaluation of what is relevant with the respondent. If the respondent answers “a tornado passed by,” the interrogator can ask specific questions with regard to the tornado.

Preferably, all respondents of a twisit are queried at least once, but only part of the respondents are queried more than five times, preferably more than four times, preferably more than three times, preferably more than twice, preferably more than once. Thereby, advantageously, it becomes possible that follow up questions to previous questions can be limited to those respondents the answers of which can be expected, judged by their previous answers, to make the greatest contribution to improving the completeness scores. As a result, the number of questions can be reduced while at the same time as more meaningful a result can be obtained from the whole of the answer signals received from the respondents.

In a preferred embodiment of the invention, in the same twisit, the interrogator continues querying a respondent until a respondent stop condition has been met. Suitable respondent stop conditions is that a query load information of the respondent has reach a first threshold.

In the context of the present invention, “query load information” is information that indicates the degree to which in a certain time interval one or more resources of the respondent has been used due to interrogation by the interrogator. A resource may, for example be the respondent's time or energy required to produce answers or answer signals to questions or question signals, the amount of data received or sent by the respondent, or the amount or duration of data transfer across a communication channel between the interrogator and the respondent; in the case of the respondent comprising a human-computer-interface for outputting information to and receiving information from a human user, the query load information may indicate a duration of use of the human-computer-interface. The certain time interval can for example be the time since the beginning of the first survey, the time since the beginning of the present survey, or a fixed past time interval, for example the past week, the past month, the past three month, the past six months or the past year.

With this embodiment of the invention, it can advantageously be avoided that the respondent's resources are overly strained. Also, it can be avoided that question signals remain unanswered, because the recipient ran out of resources. For instance, if the amount of energy available in a respondent that is a solar-powered sensing device is only sufficient for being queried for one minutes per week, or if the data plan of the mobile network through which the sensing device is connected with the interrogator only allows for ten minutes of communication per month, or if a human respondent can only spare 30 minutes of his or her time per year, querying is ended, once this limit has been reached. Alternatively, the respondent threshold is chosen lower so that only some of the interrogator's resources are used up in the twisit in order to save resources for one or more later queries, in particular in a later survey.

The constructs preferably are organised hierarchically in a way that some of the constructs are subordinate to other constructs. Preferably, a construct can have one or more other constructs as subordinates. Also preferably, a construct can be subordinate to one or more other constructs. In a preferred hierarchy, a construct can at the same time be subordinate to one or more other construct and have one or more further constructs as subordinates.

The interrogator in the selection of the one or more questions in the selection step preferably selects one or more construct(s) and then selects one or more question(s) from only those questions that are assigned to the selected construct(s) or to construct(s) that is subordinate or indirectly subordinate to the selected construct(s). In this context, a first construct being “indirectly subordinate” to a second construct means that the first construct is subordinate to at least one intermediate construct, which in turn is subordinate or indirectly subordinate (via further intermediate constructs) to the second construct.

In a preferred embodiment of the invention, some of the constructs are classified as primary constructs. Thereby, it can be indicated that these constructs are of particular relevance or importance as compared to constructs not classified as “primary”. The interrogator in the selection of the one or more questions in the selection step preferably selects the construct(s) only from this group of primary constructs. This allows the querying to be focussed on only these more relevant or important constructs, thereby reducing the amount of question signals that need to be sent and answer signals to be received for the completion of the survey.

Preferably, in at least one of the surveys at least one twisit comprises
(d) A confidence evaluation step in which the interrogator assigns to at least one construct with regard to at least one population a confidence score that is obtained by using information from answer signals which the interrogator has received previously in the same survey from the respondent.

When a recipient that has been queried before is queried again in the same twisit, the interrogator in the selection of the one or more questions for the respondent uses one or more confidence scores that are obtained by using information from previous answer signals form the same respondent. It is an achievable advantage of this embodiment of the invention that based on the confidence score, the interrogator can decide whether to ask more questions about the same construct, ie to further “exploit” the construct, or to move on to another construct, ie “explore” another construct.

In the context of the present invention, the “confidence score” reflects the confidence in the reliability a value derived from the recipient answer(s) concerning the construct for which the confidence score is calculated. Preferably, it reflects a margin of error or a standard error of the value in the sense that the confidence score is the higher, the lower the margin of error is with respect to the statistical conclusions. The confidence scores preferably are normalized so that confidence scores assigned to different constructs can be compared with each other.

The confidence scores may, for example, be obtained from the answers contained in the answer signal, for example from the degree to which the answer is self-consistent or the degree the answer contains credible information in support of the answer. For example, if a respondent is a weather sensor device, and in addition to the answer “18” to the question “what is the air temperature?” provides the measurements of three independent temperature sensors, from which it has averaged the result, these can be used to calculate a confidence of the result; in this case, widely varying measurements of the three sensors may indicate a low confidence; for example, similarly to the case of the completeness score, the value could be the average or median of these three answers, and the confidence score could be the inverse relative standard error. Alternatively or in addition, the confidence score may also be derived from reliability indicating data contained in the answer signal. This may for example be a confidence or a margin of error provide by the respondent with regard to the answer(s), or it may be the time required by the respondent to answer the question; in the latter case, if the respondent is human or obtains its answers from a human, a short time required by the respondent or the human to answer the question may indicate that the human has not sufficiently contemplated the question and therefore the confidence in the answer's reliability is low, resulting in a low confidence score.

Typically, there is more than one construct. In a preferred embodiment of the invention, in at least one of the surveys—preferably in all surveys—in at least one of the twisits—preferably in all twisits—in the question selection step the interrogator for the respondents of at least one of the populations selects questions with regard to several constructs. It is an achievable advantage of this embodiment of the invention that estimates about several constructs can be obtained in the same survey. Preferably, in the question selection step for at least some of the participants question(s) are selected that is assigned to several constructs. For example, these participants are asked at least one question with regard to one construct and at least one other question with regard to another construct; or they are asked at least one question that is with regard to two constructs. The latter exploits the fact that a question may not necessarily be assigned only one construct but may also be assigned one or more other construct(s). For instance, in the example of a weather sensor device, the question “What is the relative humidity in percent?” could be relevant to both the “apparent temperature” construct and a “humidity” construct. Yet, the invention also includes embodiments in which each participant is always only asked questions with regard to one construct.

Preferably in at least one survey—more preferably all surveys—in at least one—preferably all—twisit(s), the confidence evaluation step is functionally connected to the question selection step of the same twisit in such a way that when new questions are selected, most, more preferably all of the answer signals received from the respondent and processed by the interrogator before this moment, are considered in the question selection. As is the case with all steps, the confidence evaluation step can overlap with any other steps. In particular, the confidence evaluation step may continue as long as in the question selection step has not finished selecting all of the questions to be asked in a twisit. In this case, preferably, before each selection of new questions(s), confidence evaluation step calculates the most current confidence scores, considering all new answer signals that have arrived and been processed since the last selection of questions, and the question section step uses these scores.

Preferably, in the selection of the one or more question(s) in the selection step the interrogator selects the question(s) only from questions assigned to constructs the confidence score of which is below a first confidence threshold. In other words, if the confidence score of a particular construct is above a certain threshold, the interrogator cannot further exploit this construct but must explore other constructs or, if all constructs that have been selected have confidence score above the confidence threshold, end querying the respondent.

Preferably, once the interrogator has started querying the respondent about a construct, it continues querying the respondent about this construct until one of one or more construct stop conditions are met. A preferred construct stop condition is that the confidence scores of the construct and all subordinate and indirectly subordinate constructs are above the confidence threshold. In other words, the before moving to another construct, the interrogator exploits the present construct until the confidence threshold has been surpassed. This way, it can be ensured that a construct is properly exploited before the interrogator moves on to the next construct. Another preferred construct stop condition is that the interrogator runs out of questions, ie, all questions assigned to the construct, its subordinate constructs and its indirectly subordinate constructs have been asked. Preferably, every question associated with any construct (subordinated or not) is asked only once to the respondent in order to avoid redundancy.

In a preferred embodiment of the invention, in at least one of the surveys—preferably all surveys—at least one twisit—preferably all twisits—comprise(s)
(e) A relevance evaluation step in which the interrogator assigns to at least one question with regard to at least one construct a relevance score that is obtained by using information from answer signals which the interrogator has received previously, and wherein

the interrogator in the selection of the one or more questions uses one or more of the relevance scores.

Preferably, the relevance score is obtained by using information from answer signals which the interrogator has received previously from any respondents, more preferably from any survey. Considering all respondents and/or all surveys has the advantage that a large sample is available for obtaining the relevance scores, thereby improving the statistical significance of the relevance scores.

In the context of the present invention, a “relevance score” reflects the likely extent to which the respective question provides insight concerning the construct for which the confidence score is obtained. Preferably, the relevance scores are normalised so that relevance scores assigned to different questions with regard to the same construct can be compared with each other. The relevance scores may for example be the average of all confidence scores obtained in all populations and surveys so far with regard to this construct.

Preferably, the relevance scores are proportional to the likelihood of receiving an answer of a certain relevance; in other words, the ratio of any pair of relevance scores with regard to the same construct is the ratio of the likelihood of receiving answers of the same relevance from the pair of questions to which the relevance scores are assigned. Thus, for example, if the likelihood that a question A yields an answer with relevance “10” with regard to a certain construct is twice as high as the likelihood that a question B yields an answer of that relevance to that same construct, question A's relevance score with regard to this construct preferably is twice as high as that of question B with regard to the same construct.

Preferably, the relevance scores are proportional to the average or median relevance of an answer received. In other words, the ratio of any pair of relevance scores with regard to the same construct is the ratio of the average or median relevance of the answers received from the pair of questions to which the relevance scores are assigned. Thus, for example, if the median relevance of an answer that a question A yields with regard to a certain construct is twice as high as the median relevance of the answer that a question B yields with regard to that same construct, question A's relevance score with regard to this construct preferably is twice as high as that of question B with regard to the same construct.

In the context of the present invention, a “relevance” of an answer for a construct reflects the contribution the answer can make to improve the construct's confidence score. Accordingly, the relevance score can help the interrogator to select those questions that prompt the most insightful answers. For this purpose, preferably, the interrogator in the selection of the one or more questions in the selection step first selects one or more construct(s) and then selects one or more question from all question(s) or a subset of all questions based on the questions' relevance scores with regard to the construct.

Preferably, in selecting a question from all questions or a subset of all questions based on the questions' relevance scores, the interrogator selects the questions in a way that the likelihood that a question is selected is the higher, the higher the question's relevance score with regard to this construct is. Preferably, to achieve this, the questions are chosen randomly but are weight depending on their relevance score. Preferably, the likelihood a question to be selected, at least at relevance scores above a certain threshold, is linearly related to the relevance score. Preferably, the likelihood a question to be selected, at least at relevance scores below a certain threshold, is not proportional to the relevance score; rather, particularly preferably, at relevance scores below a certain threshold, the likelihood of a question to be selected is disproportionally high. It is an achievable advantage of the latter that even questions with a low relevance score are used frequently enough to be able to assess their relevance.

### Completeness

Preferably, in at least one of the surveys—preferably in all surveys—in the question selection step of at least one twisit—preferably in all twisits—the interrogator in the selection of the one or more questions for the respondent(s) uses information about the answer signals which the interrogator has received previously in the same survey. It is an achievable advantage of this embodiment of the invention that by using information about the answer signals received previously in the same survey, particularly suitable new questions can be selected. In this regard, “received previously in the same survey” means received previously in the same twisit or in a previous twisit of the same survey. For example, if in a first twisit incomplete or inconsistent answers have been received with regard to a particular construct, this can be made up for by asking more questions about this construct in the same twisit or in a subsequent twisit. In particular, by means of appropriate selection of the questions it is achievable that in the survey as a whole the reliability of the conclusions derived from the answers can be maximised. In other words, the number of questions can be reduced while at the same time more meaningful a result can be obtained from the whole of the answer signals received from the respondents.

In a preferred embodiment of the invention, in at least one of the surveys—preferably in all surveys—at least one twisit—preferably in all twisits—comprise(s)
(a) A completeness evaluation step in which the interrogator assigns to at least one construct with regard to at least one population a completeness score that is obtained by using information from answer signals which the interrogator has received previously in the same survey from respondents of the respective population.

Preferably, the interrogator assigns to several or, preferably, all constructs with regard to several or, preferably, all populations a completeness score using information from answer signals which the interrogator has previously received in the same survey from respondents of the respective population. For example, if there are three constructs to which completeness scores are assigned with regard to two populations, there are six completeness scores in total. These completeness scores can, advantageously, be used for selecting questions, as is explained in more detail below. Accordingly, in at least one of the surveys—preferably in all surveys—in the question selection steps of at least one twisit —preferably in the question selection steps of all twisits—the interrogator in the selection of the one or more questions uses one or more—preferably all—of the completeness scores.

In the context of the present invention, a “completeness score” reflects the confidence in the reliability of an estimate derived from the answers that concern the construct for which the completeness score is calculated and have been received during the survey. The estimate can for example be the average or median value of the answers. Preferably, the completeness score reflects a margin of error (also sometimes referred to as the “standard error”) in the estimate in the sense that the confidence reflected by the completeness score is the higher, the lower the margin of error is with respect to the statistical conclusions. The term “completeness score” stems from the fact that it can be used to assess to what extend the survey with regard to the respective construct is complete: If the estimate is of high confidence, this the survey can be considered “complete” with regard to this construct.

The completeness scores preferably are normalized so that completeness scores assigned to different constructs can be compared with each other. Similarly, the completeness scores preferably are normalized so that completeness scores assigned to different populations can be compared with each other. In the example discussed before where the respondents are weather sensor devices, the interrogator might ask a number of such sensors the three questions “what is the air temperature in degrees centigrade?”, “what is the relative humidity in percent?” and “what is the wind speed in metres per second?” and derive from the answers an estimate of the construct “apparent temperature”. This estimate will have a standard error, and the completeness score may, for example, be the inverse value of this standard error times a normalisation factor that renders the completeness scores of different constructs and populations comparable with each other; normalisation can for example be achieved by using the inverse specifically of the relative standard error as the completeness score. Based on the completeness score, in the question selection step the interrogator can prioritise those questions that concern the constructs the estimate of which are least reliable so that a minimum reliability throughout all estimates can be improved.

Preferably, the completeness evaluation step is functionally connected to the question selection step in such a way that when new questions are selected, most, more preferably all of the answer signals received and processed by the interrogator before this moment, are considered in the question selection. As is the case with all steps, the completeness evaluation step can overlap with any other steps. In particular, the completeness evaluation step may continue as long as in the question selection step has not finished selecting all of the questions to be asked in a twisit. In this case, preferably, before each selection of new questions(s), the completeness evaluation step calculates the most current completeness scores, considering all new answer signals that have arrived and been processed since the last selection of questions, and the question section step uses these scores.

In preferred embodiment of the invention, in calculating the completeness score, the information from answer signals which the interrogator has received previously in the same survey is weighed based on confidence scores assigned to this information. It is an achievable advantage of this embodiment of the invention that a distortion of the completeness score due to variation in the confidence of answer signals or the information contained in these signals between respondents can be avoided.

One preferred way to use the completeness scores in the question selection step is that when selecting questions to the respondents of the at least one of the populations the interrogator favours questions that are related to constructs that have lower completeness scores over those that are related to constructs with higher completeness scores. This can be applied to one, several or all populations. In one embodiment of the invention, the above comparison is only made within a population, ie, only within each population, questions that are related to constructs that have lower completeness scores are favoured over those that are related to constructs with higher completeness scores. As a result, a rapprochement in each population individually can be achieved. In another embodiment, the comparison is made across all population, ie, questions that are related to constructs that have lower completeness scores are favoured over those that are related to constructs with higher completeness scores regardless of whether the two are from the same population or not. As a result, rapprochement with regard to the potential respondents as a whole can be achieved.

In this context, a question is referred to as “related” to a construct if it is assigned to that construct or if it is assigned to another construct that is directly or indirectly subordinate to the construct. The latter occurs if the constructs are organised hierarchically in a way that some of the constructs are subordinate to other constructs. To “favour” means that questions that are related to constructs that have lower completeness scores are statistically overrepresented relatively those that are related to constructs with higher completeness scores. As a result, advantageously, a rapprochement of completeness scores can be achieved, ie, at the end of a survey, the estimates with regard to all constructs have approximately the same completeness score and thus are similarly reliable. In a particularly preferred embodiment of the invention, specifically those questions are selected that are related to constructs that have lower completeness scores than—or have equal completeness sores as—the constructs related to questions that are not selected. This can be achieved, for example, by ranking the questions by their related constructs' completeness scores and selecting the question according to their rank.

A preferred embodiment of the invention comprises, at least for one construct with regard to one population, a pre-determined completeness threshold that indicates when the confidence in the result for the construct has reached a satisfactory level. Preferably, in at least one of the surveys—preferably in all surveys—in at least one—preferably all—of the survey's twisits, in the question selection step, one or more—in some embodiments all—of the completeness scores are compared with a pre-determined completeness threshold, and only question are selected which are assigned to at least one construct the completeness score of which has not surpassed the completeness threshold. Thereby, it can advantageously be achieved that no questions are asked beyond what is necessary to achieve the required confidence in the results with regard to various constructs and populations. The completeness threshold can be the same for all completeness scores with regard to the same construct or the same population, or the completeness threshold can even be the same for all completeness scores in an entire survey or all surveys. The constructs the completeness scores of which are compared to the completeness threshold can be those that further below are referred to as primary constructs. Using for the stop criterion only to a limited number of constructs allows the querying to be focussed on only the more relevant or important constructs, thereby reducing the amount of question signals that need to be sent and answer signals to be received for the completion of the survey.

Preferably, the survey is stopped with regard to a population when the completeness scores of a set of pre-determined constructs, particularly the primary constructs referred to below, with regard to the population has surpassed the completeness threshold.

Keeping the number of participants in the twisits following the first twisit low can help to avoid asking more questions to participant than are needed to reach the required completeness score. This is, ia, because if one or a few of the participants of a twisit provide answers that contribute above average to the completeness score in the result with regard to a construct, this may already be sufficient to fulfil the completeness threshold and no further participants may be needed to be queried. Particularly preferably, at least one of the surveys—preferably all surveys —comprise(s) at least two twisits and in each twisit other than the first twisit of the survey, in the question selection step from each population there are less than 50 participants selected, particularly preferably less than 20 participants, particularly preferably less than 10 participants, particularly preferably less than 5 participants, particularly preferably less than 3 participants, particularly preferably 1 or no participant.

Representativeness

In a preferred embodiment of the invention, in at least one of the surveys—preferably in all surveys—in the respondent selection step of at least one twisit other than the survey's first twisit—preferably of all twisits other than the survey's first twisit—the interrogator uses information about at least some of the respondent(s) from which the interrogator has received an answer in a previous twisit of the same survey. Thereby, in the respondent selection step of the further twisit a particularly suitable subset of respondents can be selected.

According to this embodiment of the invention, a first twisit is followed by at least one further twisit, and in this further twisit, a new subset of respondents is selected. It is an achievable advantage of this aspect of the invention that by using information about respondents from which the interrogator has received an answer in a previous twisit of the same survey, in the respondent selection step of the further twisit a particularly suitable subset of respondents can be selected. For example, if in a first twisit no or only few answer signals form a particular kind of respondents were received, in the next twisit this can be made up for by including more respondents of this kind. In particular, by means of appropriate selection of the subset of the further twisit(s) it is achievable that in the survey as a whole the relevance of the answer signals can be maximised. In other words, the number of respondents can be reduced while at the same time as more meaningful a result can be obtained from the whole of the answer signals received from the respondents.

The information received by the interrogator from the recipient can for example include an intrinsic characteristic of the recipient or information related to this interaction. In the latter case, the information can for example include information of whether an answer signal has been receive from this respondent or not, or it could include at least part of the answer, ie, the content of the corresponding answer signal. For instance as explained in more detail further below, from the information of whether an answer signal has been receive from this respondent or not in the previous twisit, the interrogator can derive a response rate, ie the fraction of respondents that can be expected to send an answer in the current twisit, and it can accordingly choose the size of the subset such that a sufficient number of answer signals can be expected to be received in order to be able to obtain a meaningful result from the answer signals received in the survey as a whole.

Preferably, in at least one of the surveys—preferably in all surveys—in the respondent selection step of the survey's first twisit, the interrogator considers the values of at least one level of at least part of the potential respondents.

In a preferred embodiment of the invention, in at least one of the surveys—preferably in all surveys—in the respondent selection step of the survey's first twisit, the subset is selected such that it is representative of at least one population of potential respondents, preferably of all populations of potential respondents. In the context of the present invention, to be “representative” means that a pre-determined degree of representativeness is achieved.

In the context of the present invention, “representativeness” refers to the degree to which with regard to at least one, preferably several level(s), the relative proportions of the subset's participants assigned to various values of the level(s) are close to the relative proportions of the population's potential participants assigned to various values of the level(s) within a pre-determined metric.

In the context of the present invention, a “level” is an information that stratifies the population in the sense that each potential respondent is assigned one and only one value of the level thereby assigning the population to collectively exhaustive and mutually exclusive strata of this level. Preferably, a level is an intrinsic characteristic of the respondent, for example its location or sub-location within a cell (for example “Zurich” in the cell “Switzerland”), age, rank in an organisation, or task area or sub-task area (for example “software development” in the task area “research and development”). It may also be a combination of such intrinsic characteristics, for example the combination of location and task area. The population may have one or more levels. Preferably, at least two levels are considered for representativeness, and Cramer's V with the relative proportions as values is used as the degree of representativeness.

Preferably, in the first twisit of the survey, the participants are selected such that a pre-determined degree of representativeness is achieved with a small number of selected respondents. In this, other constraints may be taken into account. For example, the subset may be required to include such participants that in certain levels are assigned to a value or values that is/are particularly rare in one or more population(s) of potential participants. Accordingly, in a preferred embodiment of the invention, in at least one of the surveys —preferably in all surveys—in the respondent selection step of the survey's first twisit, the subset is selected such that it a pre-determined degree of diversity is achieved with regard to at least one population of potential respondents, preferably of all populations of potential respondents.

“Diversity” In the context of the present invention is the degree to which the rarest combinations of levels are represented in the subset. Accordingly, a respondent's “contribution they make to the representativeness of the subset” is the higher, the rarer its combination of levels is. Thereby, it is achievable that respondents with the rarest combinations are selected early on, which can, advantageously, contribute to obtaining a more diverse subset of respondents. This exploits that representatives with more common combinations of levels can be used later on to correct for over- or under-represented samples, if needed.

It is preferred that in at least one of the surveys—preferably in all surveys—in the respondent selection step of at least one of the survey's twisits other than the first twisit, the interrogator preferably uses information about all respondent(s) from which the interrogator has received an answer in any previous twisit of the same survey. Preferably, the information about the respondent(s) comprises the values of at least one level of the respondents. Particularly preferably, the interrogator selects the subset such that a set consisting of the subset and all respondent(s) from which the interrogator has received an answer in a previous twisit of the same survey is representative of one or more population(s) of potential respondents.

In a preferred embodiment of the invention, in at least one of the surveys—preferably in all surveys—the respondent selection step of at least one of the survey's twisits other than the first twisit, comprises a prognosis sub-step in which for at least part of the population of potential respondents the interrogator calculates a likelihood that a question signal sent to a potential respondent results in an answer signal received from this potential respondent. This can be achieved, for example, simply by dividing the number of respondents of the directly preceding twisit, all previous twisits of the survey or even all previous twisits also of previous surveys, from which answer signals have been received by the total number of these respondents. Thereby, advantageously, it can be calculated how much respondent must be interrogated in order to receive a certain number of answer signals.

Preferably, the interrogator selects the subset such that a set consisting of the respondents in the subset from which according to the prognosis an answer signal will be received and all respondent(s) from which the interrogator has received an answer in a previous twisit of the same survey is representative of the of one or more population(s) of potential respondents. For example, if representativeness requires a certain number of additional answer signals from respondents with a certain level assigned to certain values (for instance the level “location” having the value “Zurich”), based on the prognosis it can be calculated how many respondents with these values the interrogator need to interrogate in order to receive this additional number of answer signals.

In a preferred embodiment of the invention, in of at least one of the surveys—preferably in all surveys—in the respondent selection step of at least one twisit—preferably of all twisits—the interrogator uses query load information about at least part of the potential respondents. It is an achievable advantage of this aspect of the invention that by considering the query load information of potential respondents, the respondents can be selected or at least prioritised based on the query load information. For example, only respondents are selected which still have resources available for an interrogation, or the respondents with the most resources available are prioritised. For instance, if the amount of energy available in a respondent that is a solar-powered sensing device is only sufficient for being queried for one minutes per week, or if the data plan of the mobile network through which the sensing device is connected with the interrogator only allows for ten minutes of communication per month, or if a human respondent can only spare 30 minutes of his or her time per year, only those respondents are selected that have sufficient time left for interrogation. Alternatively, the threshold is chosen lower so that only some of the interrogator's resources are used up in the twisit in order to save resources for one or more later queries, in particular in a later survey.

Preferably, in at least one of the surveys—more preferably in all surveys—in the respondent selection step of at least one twisit—more preferably of all twisits—the subset selected by the interrogator comprises only respondents the query load of which is below a pre-defined threshold. Thereby it can be achieved that only respondents are queried that have sufficient resources left to produce an answer signal.

In a preferred embodiment of the invention, the query load information comprises the time used in a certain time interval by the respondent due to interrogation by the interrogator. Preferably, this certain time is two hours or less, more preferably one hour or less, more preferably 30 minutes or less, more preferably ten minutes or less. Preferably, the time interval is the past two years or less, more preferably the past year or less, more preferably the past six months or less, more preferably the past three months or less, more preferably the past month or less, more preferably the past week or less.

In some embodiments of the invention, in at least one of the surveys—more preferably in all surveys—in the respondent selection step of at least one twisit—more preferably of all twisits—the subset selected by the interrogator does not comprise respondents from which the interrogator has received any answer signal in other twisits of the same survey. With this, it can advantageously be achieved that each answer signals in a survey originate from a different potential respondent, which can improve the survey's representativeness.

In some embodiments of the invention, in at least one of the surveys—more preferably in all surveys—in the respondent selection step of at least one twisit—more preferably of all twisits—the subset selected by the interrogator does not comprise respondents from which no answer signal in response to a question signal has been received in the same survey, more preferably in any of the surveys. With this, advantageously, the response rate can be improved.

In a preferred embodiment of the invention, in at least one of the surveys—preferably in all surveys—in the first twisit of the query cycle in the selection step the interrogator ranks at least some of the respondents of the subset in an order that considers the contribution they make to the representativeness and/or diversity of the subset with regard to one or more of the population(s). In the context of the present application, a respondent's “contribution they make to the representativeness of the subset” is the amount to which the representativeness is improved within the pre-determined metric. It is an achievable advantage of this embodiment of the invention that a high degree of representativeness and diversity can be achieved early on in the twisit. As a result, for example, the twisit and the survey can be aborted once a sufficient representativeness has been achieved. Preferably, in the interrogation step the interrogator sends question signal(s) to the one or more respondent(s) in a temporal order that considers the rank of the ranked respondents.

In a preferred embodiment of the invention, in at least one of the surveys—preferably in all surveys—in the selection step of at least one—preferably all—twisit(s) other than the survey's first twisit the selection step comprises a prognosis sub-step in which for at least part of the potential respondents the interrogator calculates a likelihood that a question signal sent to a potential respondent results in an answer signal received from this potential respondent. Preferably, in the selection step the interrogator ranks at least some of the respondents of the subset in an order that considers the contribution they make to the representativeness with regard to one or more of the population(s) of a set consisting of the respondents in the subset from which according to the prognosis an answer signal will be received and all respondent(s) from which the interrogator has received an answer in a previous twisit of the same survey. As in the previous embodiment, it is an achievable advantage of this embodiment of the invention that a high degree of representativeness can be achieved early on in the twisit. As a result, for example, the twisit and the survey can be aborted once a sufficient representativeness has been achieved. Also preferably, in the interrogation step the interrogator sends question signal(s) to the one or more respondent(s) in a temporal order that considers the ranks of the ranked respondents.

In a preferred embodiment of the invention, least one of the surveys—preferably all surveys—comprise(s) an invitation step in which the interrogator sends opt-in invitation signal(s) to at least part of the potential respondents, and in the respondent selection step of at least one—in some embodiments all twisits—of the survey(s), the interrogator includes one or more respondent(s) into the subset due to the interrogator having received an opt-in signal from these respondent(s) in response to the opt-in invitation signal. With this, advantageously, the response rate in the interrogation step(s) of the twisit can be improved. Preferably, the invitation step is included in the first twisit of at least one survey, preferably all surveys.

Preferably, each survey includes one or more analysis steps in which the answer signals are analysed in order to derive conclusions about the population(s). These may for example be the average temperature or amount of precipitation in a location of the population(s) or the average temperatures or amounts of precipitation in the locations of the individual cells of the population.

By dividing the population of potential respondents into two or more populations, it can advantageously be achieved that a survey can be performed for multiple populations simultaneously. With this, for example, it is possible to readily compare the results from two or more populations with each other.

Interrogator

A preferred interrogator comprises: a bus; a communications unit connected to the bus; a first memory connected to the bus, wherein the first memory stores a set of computer useable program code; a processor connected to the bus, wherein the processor executes the set of computer useable program code to perform a method according to the invention. Preferably, the interrogator further comprises a second memory, wherein the second memory stores information about each of the plurality of constructs.

### BRIEF DESCRIPTION OF THE DRAWINGS

In the following, further preferred embodiments of invention are illustrated by means of examples. The invention is not limited to these examples, however.

The drawings schematically show:

FIG. 1 An embodiment of an interrogator according to the present invention, the interrogator performing methods according to the present invention

FIG. 2 An embodiment of a computer network according to the invention, the computer network performing methods according to the present invention;

FIG. 3 A functional diagram of the computer network of FIG. 2 for explaining the processes and information flow occurring therein; and

FIG. 4 A flow diagram of the method performed by the computer network of FIGS. 2 and 3.

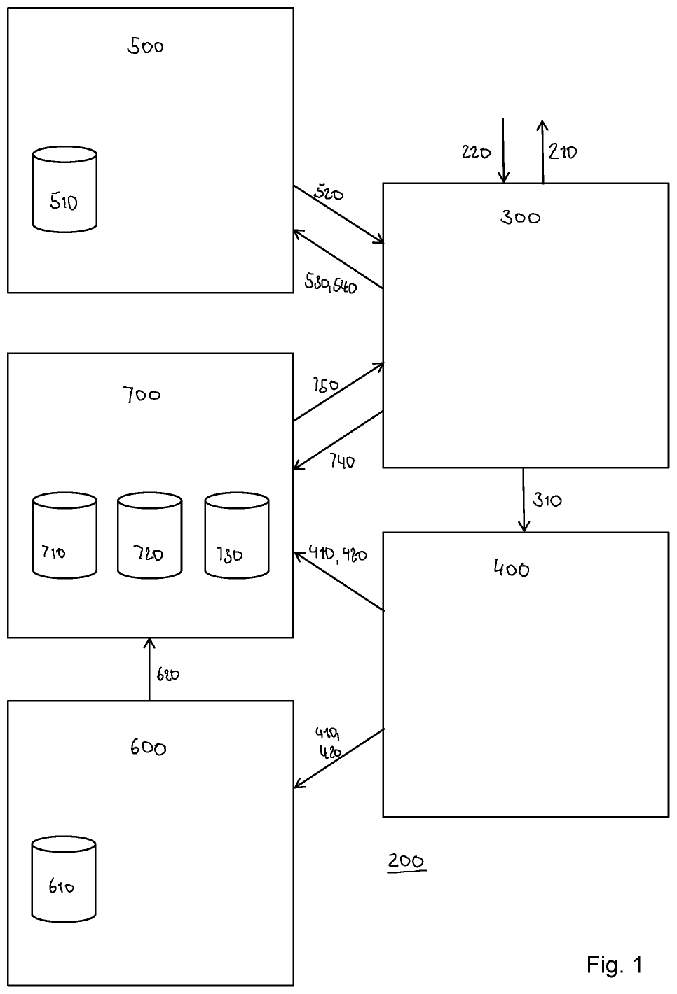

### DETAILED DESCRIPTION OF A FIRST EMBODIMENT OF THE INVENTION

### Interrogator

An interrogator 200 according to the invention can query respondents (not shown) by transmitting question signals 210 to any of multiple respondents with regard to one or more construct(s) and receiving answer signals 220 from the respondents in response to the questions signals 210.

The interrogator 200 selects the respondents from a reservoir of (typically hundreds or thousands) potential respondents. For example, the respondents are for reporting the weather, yet the method below is equally applicable to any other subject. In this specific example, some respondents are weather sensor devices that comprise either a temperature sensor or a precipitation sensor or both. The weather sensor devices can exchange the question 210 and answer signals 220 through the internet via a mobile data network which is also commonly used for mobile smartphones. Moreover, in this specific example, some other respondents are profiles that exist on a web server and can be accessed via a web browser through the internet by human informants (such as meteorologists) to manually input weather data. For this purpose, the human informants can, through the internet via a mobile data network, log into their profiles on the web server. The web server converts the question signals 210 into readable text expressing the questions contained in the question signals 210 for the human informants to read and understands. The web server also collects answers from the human informants and converts them into answer signals 220 to be received by the interrogator 200. In the specific example mentioned above, there are two populations of potential respondents, the Zurich cell and the Bern cell. Respondents of these populations provide weather data from a location in Zurich or Bern, respectively.

The interrogator 200 can perform one or more surveys. Typically, one survey is completed, before the next survey begins. Each survey comprises at least one, typically several twisit(s). Each twisit comprises several steps which usually start and end at different times but much of the time run concurrently and react upon each other. The steps comprise A respondent selection step in which the interrogator selects a subset comprising one or more respondent(s) (for example 1500);
A question selection step in which the interrogator selects one or more questions (for example 5) for each of one or more respondent(s) to be interrogated in the twisit, each question being assigned to at least one of the plurality of constructs;
An interrogation step in which the interrogator sends question signal(s) to the one or more respondent(s) of the subset;
A response step in which the interrogator receives answer signal(s) from those respondent(s) that are responsive (the response rate can be eg 60%) to the interrogator's question signal(s); and
A completeness evaluation step in which the interrogator assigns to at least one construct with regard to at least one population a completeness score that is obtained by using information from answer signals which the interrogator has received previously in the same survey from respondents of the respective population.

To execute these steps, the interrogator 200 comprises five main components, a survey engine 300, an evaluation engine 400, a representative engine 500, a completeness engine 600 and a dynamic branching engine 700. In this context, an “engine” is a logical device in the sense that the engines do not need to be implemented as separate hardware. Rather several or all of them may for example be implemented as parts of a computer program that run on the same hardware.

Survey Engine and the Evaluation Engine

The survey engine 300 performs the interrogation and response steps, ie, it sends out to the respondents previously selected in the respondent selection step the question signals 210 containing the questions previously selected in the question selection step. The survey engine also receives the answer signals 220. It forwards the answers 310 contained therein together with an indication of the corresponding question to the evaluation engine 400. The evaluation engine 400 determines for each answer and with regard to each construct which the question addresses a value of 410 the construct according to the answer 310, and a confidence score 420 of this value. In the above example, the question to “what was the temperature at noon?” the respondent reports temperatures from three different sensors, then the value is the average of these three temperatures and the confidence score is the inverse relative standard deviation obtained from the three temperatures. The confidence can also be based on eg the accuracy (temperature measured to whole degrees Celsius) or difference from the last calibration of the sensor.

Also, at the beginning of the first twisit, it performs an invitation step in which it sends opt-in invitation signals (not shown) to at least part of the population of potential respondents (for example the whole population who hasn't responded in the last 6 months), asking them if they are available for the survey. This serves to improve the response rate of the survey.

Representativeness Engine

The respondent selection step is performed in the representativeness engine 500. For this purpose, the representativeness engine keeps a respondent database 510 which comprises for each potential respondent the following information:
(i) Contact information 520 that allows the interrogator to contact the respondent for exchanging question and answer signal;
(ii) Cell information that indicates the cell(s) to which the potential respondents belongs;
(iii) Level information that indicates the values to which the potential respondent is assigned with regard to various levels;
(iv) Query information 530 that indicate if the potential respondent has already receive a question in the present survey and whether an answer has been received;
(v) Load information 540 that indicates what percentage of the potential respondent's time has already been used in the present survey and in previous surveys within the past year;
(vi) A load threshold that can be identical for all respondents or can vary between respondents; and
(vii) A rank of the respondent.

In this specific example, there are two levels, “district” and “data source”. The value of a level quarter indicates from which of the city's quarter the respondent reports and the value of a level data source indicates if the respondent obtains its data from an electrical sensor or from a human observer. The query load is the amount of time the respondent is in operation to consider and answer the questions. During each twisit, each time a new answer signal is received by the survey engine 300, the query 530 and the load information 540 are updated.

In the following, the operation of the representative engine during a survey is explained. In the survey's first twisit, the representativeness engine 500 selects a subset of respondents from both populations such that respondents they are representative of each of the two populations. Moreover, the representativeness engine 500 makes sure that for each population the subset is sufficiently diverse. For this purpose, the respondents are ranked by the contribution they make to the representativeness and diversity with regard to their respective population. As the contribution to representativeness of a respondent that is to be ranked, the difference between Cramer's V of the set of respondents already ranked and Cramer's V of a potential set of respondents that also comprises a respondent to be evaluated is used; the values in Cramer's V are the relative proportion of the values of the various levels. As the contribution to diversity, the rarity of the combination of levels is used, the respondent with the rarer combination of levels making the greater contribution to diversity. The rarity is the inverse of the fraction of potential respondents that have the same combinations of levels. The representativeness engine therefore ensures that the selected subset is representative in both size (number) and structure.

The representativeness engine 500 starts by selecting into the subset all respondents that have responded affirmatively to the opt-in invitation sent out by the survey engine 300. This can for example be 300 respondents. Then it ranks the remaining potential respondents. For this, it gives the respondent with the rarest combination of levels the highest rank and then assigns the subsequent ranks considering a combination of contributions to representativeness and to diversity. It then evaluates which of the remaining potential respondents makes the greatest contribution to representativeness and diversity. This is given the next lower rank. The process is continued until the representativeness, as measured by Cramer's V has reach a pre-determined first representativeness threshold. All respondents ranked up to this point are queried in the first twisit.

In the next twist, one or a number of further potential respondents (eg 200) are selected. For this purpose, the potential respondents are ranked again, but it is made sure by means of the query information that only
(i) respondents that have not responded to question signal with an answer signal; and
(ii) respondents the query load of which does not exceed 30 minutes within the past year

are considered. Accordingly, the representativeness engine 500 starts by calculating the difference between Cramer's V of the set of respondents from which answers 310 have been received so far and Cramer's V of a potential set of respondents that also comprises a potential respondent to be evaluated. It evaluates the addition of which of the potential respondents that fulfils requirements (i) and (ii) above makes the greatest contribution to representativeness and diversity. This is given the next lower rank. The process can be continued until a desired number or respondents is reached.

If several respondents are selected this way, the representative engine 500 chooses the number the higher, the lower the response rate, ie, the fraction of interrogated respondents from which an answer 310 has been received is. This is, because the response rate is considered by the representativeness engine 500 as indication of the fraction of the selected respondents from which the interrogator 200 will receive answers, and accordingly if the response rate is low, more respondents need to be interrogated to receive a desired number of answers.

By selecting the respondents in the second and subsequent twisits based on which respondents have so far in this survey answered questions, the representativeness engine 500 can ensure a greater degree of representativeness with a smaller set of respondents. This save communication, computing and database resources, both on the side of the interrogator and the side on the respondents.

### Completeness Engine

The completeness evaluation step is performed by the completeness engine 600. The completeness engine 600 seeks to keep low the number of questions asked with regard to each primary construct. For this purpose, the completeness engine 600 keeps a completeness database 610 of primary constructs which comprises with regard to each population for each primary construct the following information:
(i) An estimate value of the construct; and
(ii) A completeness score of the construct.

It also contains
(iii) A completeness threshold that can be identical for all constructs or can vary between constructs and/or between populations.

In this specific example above, there are two primary constructs, one concerning “temperature” and the other concerning “precipitation”. Obviously, the values and the completeness scores for each of the constructs can vary greatly from population to population. Therefore, they are gathered and kept for each population, the Zurich cell and the Bern cell, separately. During each twisit, each time a new answer signal is received by the survey engine, the estimate values and the completeness scores are updated based on the evaluation engine's 400 results 410, 420.

In the following, the operation of the completeness engine 600 during a survey is explained. For obtaining the estimate value, the completeness engine considers all values 410, 420 obtained so far from the evaluation engine 400 with regard to the construct and population which the estimate concerns. The values are weighed by their respective confidence scores as obtained from the evaluation engine 420. The completeness score is the inverted standard deviation of the estimate value.

The completeness engine 600 compare the thus obtained completeness scores with the respective completeness thresholds. Alternatively, the completeness score can be normalized, and common threshold can be used. If the completeness score exceeds the completeness threshold, the completeness engine advises 620 the dynamic branching engine 700 (discussed below) to no longer seek to gather values from the recipients with regard to this primary construct. Rather, only questions are asked which concern at least one primary construct the completeness score of which has not yet surpassed the confidence threshold. The confidence threshold can be eg set so that it's equivalent to 1% of the average score.

By monitoring the completeness of the primary constructs and effecting that once a completeness score has been exceeded questions are limited to those (at least also) concerning other constructs, the completeness engine 600 ensures that unnecessary questions are avoided. This saves communication, computing and database resources, both on the side of the interrogator and the side on the respondents.

### Dynamic Branching Engine

The question selection step is performed by the dynamic branching engine 700. The dynamic branching engine 700 seeks to make sure that for each respondent the most relevant questions are selected. For this purpose, the dynamic branching engine 700 keeps three databases, a dynamic branching database 710, a construct database 720 and a question database 730.

The dynamic branching database 710 comprises for all constructs, primary and non-primary, with regard to each respondent the following information:
(i) A value of the construct;
(ii) A confidence score of the value; and
(iii) An indication of which questions have already been asked to the respondent

It also comprises
(iv) A confidence threshold that can be identical for all constructs or can vary between constructs.

During each twisit, each time a new answer signal is received by the survey engine, the values and the confidence scores are updated based on the survey engine's results 410, 420. Also during each twisit, each time a question signal 210 has been sent to a respondent, the indication 740 of which questions have already been asked to the respondent is updated.

The construct database 720 comprises for all constructs the information:
(i) An indication of whether the construct is a primary construct or not; and
(ii) An indication of to which other construct(s), if any, the construct is subordinate

In the above example, each primary construct has two subordinate constructs. The primary construct “temperature” has the apparent temperature and the shade temperature as subordinate constructs, and the primary construct “precipitation” has the duration and the amount of precipitation as subordinate constructs.

The question database 730 comprises for all questions the following information:
(i) The question; and
(ii) The construct(s) the question is assigned to.

Moreover, it comprises for every question and for every construct the question is assigned to
(iii) A relevance score.

The relevance scores are the average of all confidence scores obtained in all populations and surveys so far with regard to this question and this construct. During each twisit, each time a new answer signal is received by the survey engine, the relevance scores are updated based on the survey engine's confidence result 410.

In the following, the operation of the dynamic branching engine 700 during a survey is explained. In the first twisit, the dynamic branching engine 700 assigns the primary constructs to the respondents of the first set of respondents selected by the representativeness engines at random while ensuring that about the same number of respondents are assigned to each primary construct. Then, for each respondent it selects a question regarding the assigned construct or a construct subordinate to this construct at random but weighed based on the question's relevance score with regard to the construct and its subordinate constructs such that questions with a higher relevance score are selected more frequently than questions with a lower relevance score. The survey engine 300 is instructed 750 to send these questions to the respondents, and as answers come in, the dynamic branching database 710, the completeness database 610 and the representativeness database 510 are updated.

Based on the confidence scores, the dynamic branching engine 700 selects follow-up question(s) for the respondent(s), as long as the load information as recorded in the representativeness database 510 must not be expected to exceed the load threshold with the next question or there is another reason for aborting the querying of the respondent such as, for example, that the dynamic branching engine 700 observes that the respondent is unreliable in general. If the primary construct or at least one of the subordinate constructs has not yet exceeded the confidence threshold, the primary construct is exploited, ie, questions assigned to these constructs, primary and/or subordinate, are selected, again based on their respective relevance scores as explained above.

If, however, the primary construct and all of its subordinate constructs have surpassed the confidence threshold, the dynamic branching engine 700 explores towards a new primary construct. For this, the dynamic branching engine select from all construct one that has the lowest completeness score. The dynamic branching engine 700 may also for other reasons explore a new primary construct rather than further exploiting the present primary construct, for example if the responded fails to provide reliable answers with regard to this construct. With regard to the new construct, in the same way as explained before the dynamic branching engine 700 selects a question regarding the newly assigned construct or a construct subordinate to this construct at random but weighed based on the question's relevance score with regard to the construct and its subordinate constructs such that questions with a higher relevance score are selected more frequently than questions with a lower relevance score. The survey engine 300 is instructed 750 to send these questions to the respondents, and as answers come in, the dynamic branching database 710, the completeness database 610 and the representativeness database 510 are updated.

Once the querying of every respondent of the twisit has been ended, the process moves to the next twisit, and the dynamic branching engine 700 continues with the new set of respondents selected by the representativeness engine 510. The dynamic branching engine 700 assigns to the respondent(s) the construct or constructs that has the lowest completeness score. In the same way as explained before, the dynamic branching engine 700 selects a question regarding the newly assigned construct or a construct subordinate to this construct at random but weighed based on the questions relevance score with regard to the construct and its subordinate constructs such that questions with a higher relevance score are selected more frequently than questions with a lower relevance score. The survey engine 300 is instructed 740 to send these questions to the respondents, and as answer signals 220 come in, the dynamic branching database 710, the completeness database 610 and the representativeness database 510 are updated.

The dynamic branching engine 700 ends the survey if all completeness scores are above the completeness threshold and the representativeness of the set of respondents from which answers have been received surpasses a second representativeness threshold which, usually, is higher than the first representativeness threshold. There may be other conditions on which the survey is also ended, for example if a maximum number of respondents have been interrogated, for example 25% of the total number of potential respondents.

### Detailed Description of a Second Embodiment of the Invention

This embodiment of the invention is specifically directed towards a use case in which responses, preferably answers according to the present invention, are gathered from members of large organisations, such as employees of a company, eg via an online survey or online questionnaire. This may be employed to perform a performance analysis or leadership analysis of the company and/or to determine a level of employee satisfaction.

Existing solutions suffer from several drawbacks. For example, in order to evaluate characteristics of interests, preferably constructs according to the present invention, in a sufficiently precise and reliable manner, a large number of responses may have to be provided by each user. For example, for receiving statistically significant results, many similar and/or related questions may have to be posed to the same user which more or less concern the same topic. This may be perceived as lengthy and inefficient. Importantly, however, this increases the time required for conduction online surveys. Also, this increases the overall amount of data that have to be exchanged between computer devices involved in the survey. The latter may result in a need for respectively large communication bandwidths and communication volumes, this being particularly undesired for mobile computer devices, such as smartphones. Likewise, this increases the number of data having to be analysed and/or computed, thus requiring respectively large computational capabilities, data storage means and/or respectively large computation times.

An object of this embodiment of the invention is to improve existing ways of using computer networks for gathering responses from users (eg via online surveys), in particular with regard to reducing the time and effort for conducting the response (ie data) gathering and/or for analysing the received responses (ie data). Generally, the solutions disclosed herein may be directed to alleviating any of the above-mentioned drawbacks.

According to a basic idea of this embodiment of the invention, much like in existing solutions, an initial set of predetermined “response tasks”, preferably questions according to the present invention, may be received from users. Preferably, the users are respondents or are provided with the questions through respondents according to the invention. Yet, instead of the user having to work himself through all of these response tasks, this initial set of response tasks may be adjusted and in particular reduced. This reduces both the burden from the users' as well as from a general computational perspective. This way, an adjusted set of response tasks may be generated. Generally, the response tasks of the initial set may be referred to as structured response tasks, since they may comprise predetermined response options as is known from standard online surveys. As discussed below, they may also produce structured (response) data that eg directly have a desired processable format. Such response options typically allow the user to provide his response to a response task by performing selections, scalings, weightings, typing in numbers or text or by performing similar inputs of an expected type and/or from an expected range.

Yet, according to the disclosed solution, as a preferably first response task, a free-formulation response task may be output to a user (and preferably to a number of users). This task may, contrary to the initial set of response tasks, be free of any predetermined response options (ie may be unstructured and/or produce unstructured (response) data as discussed below that typically represent unprocessable raw data). Instead, the free-formulation response task may be answered or, differently put, may be completed by a freely formulated input of the user (eg speech or text or an observed behavior eg during interaction with an augmented reality (AR) system). An example would be to ask the user for his opinion on, his understanding of or a general comment on a certain topic. The user may then eg write or say an answer and this may be recorded and/or gathered by the computer network.

Following that, eg by way of a software-based computerised analysis, the user's freely formulated response may be analysed. Specifically, information that are usable for evaluating at least one construct in the form of a “characteristic of interest” (preferably one that is also to be evaluated by the initial set of response tasks) may be identified from the freely formulated response. As will be detailed below, this may be done by respectively configured computer algorithms or software modules. For example, it may be identified whether a user speaks positively or negatively about a certain characteristic of interest and/or which significance the user assigns to certain characteristics. Such information may be translated into an evaluation score for said characteristic.

Thus, the analysis of the freely formulated response may include steps of identifying which characteristics are concerned by the freely formulated response and/or how this characteristic is evaluated by the user (positive, negative, important, not important etc.). The freely formulated response may represent unstructured data. According to standard definitions, such unstructured data do not comply with a specific structure or format (eg desired arrays or matrices) that would enable them to be analysed in a desired manner (eg by a given algorithm or computer model). They may thus represent raw data that is unprocessable eg for a standard evaluation algorithm of an online survey that is only configured to deal with selections from predetermined response tasks. Accordingly, the present solution may include dedicated analysis tools (eg computer models) for extracting evaluation information for such unstructured data. To the contrary, evaluation information determined via the predetermined response tasks may be structured since they already comply with a desired format or structure (eg in form of arrays comprising selected predetermined response options).

To sum up, the freely formulated response may be analysed to determine, whether the user has already provided at least some or even sufficient evaluation information for at least one characteristic that should also be evaluated by the initial set of response tasks. If that is the case, the initial set of response tasks may be adjusted accordingly and/or a generally new adjusted set of response tasks may be generated. Again, this adjusted set of response task may include predetermined response task with predetermined response options but, as noted above, the number of said response tasks and/or response options may be different from the initial set and may in particular be reduced.

This way, the number of predetermined response tasks that the user has to answer in a subsequent stage (ie when answering the adjusted set) can be reduced. This, in turn, also means that the amount of generated data having to be stored, processed or communicated can be reduced at least in said subsequent stages. This allows for a faster and more efficient operation of the overall computer network, eg since the online survey generally occupies the computer network for a shorter time period and/or uses less resources thereof.

This may be particularly valid when, according to an embodiment of the invention, analysing tools for the freely formulated response (eg models and/or algorithm) and/or adjustment tools for the initial set of response tasks are directly stored on user devices. This way, the freely formulated response of a user does not have to be communicated to a remote analysing tool (much like no analyses results have to communicated back from said tool) which further limits the solution's impact on and resource usage of the overall computer network.

Specifically, a method for gathering evaluation information from a user with a computer network is suggested, the computer network performing the following, ie performing the following method steps:
receiving an initial set of predetermined response tasks, each response task including a number of predetermined (eg user-selectable) response options (eg in form of a predetermined input option), wherein based on the response options selected by a user, evaluation information for evaluating at least one predetermined characteristic are determined (or, differently put, gathered);
outputting, via a computer device of said computer network, at least one free-formulation response task to the user by means of which an at least partially freely formulated response can be received from the user;
identifying (eg by a computerised analysis), via a computer device of said computer network, evaluation information based on the freely formulated response, said evaluation information being usable for evaluating the at least one predetermined characteristic;
(preferably automatically) generating, via a computer device of said computer network, an adjusted set of predetermined response tasks based on the identified evaluation information; and preferably
outputting the adjusted set of predetermined response tasks to the user.

Preferably, a large number of users is dealt with eg by outputting a free-formulation response task and/or the adjusted set to several hundred users. The analysis may then equally focus on all of the freely formulated responses and the adjusted set may be generated based on the identified evaluation information (particularly evaluation scores, preferably in the form of values of constructs) received from all of the users.

If in the following referring to a user, it is to be understood that this may be one out of a plurality of users and that each of the further users may be addressed and/or interacted with in a similar manner.

As will be detailed below, the computer network and in particular at least one computer device thereof (eg the central computer device discussed below) may comprise at least one processing unit (eg including at least one microprocessor) and/or at least one data storage unit. The data storage unit may contain program instructions, such as algorithms or software modules. The processing unit may use these stored program instructions to execute them, thereby performing the steps and/or functions of the method disclosed herein. Accordingly, the method may be implemented by executing at least one software program with at least one processing unit of the computer network.

The computer network may be and/or comprise a number of distributed computer devices. Accordingly, the computer network may comprise a number of computer devices which are connected or connectable to one another, eg for exchanging data therebetween. This connection may be formed by wire-bound or wireless communication links and, in particular, by an internet connection.

For performing the method, users may access an online platform by user-bound computer devices of the computer network. The online platform may be provided by a server of the computer network. Typically, the online platform holds user profiles for the users. The server may optionally be connected to a central computer device which, eg, performs the identification/analysis of freely formulated responses and/or includes the computer model discussed below. Additionally or alternatively, the central computer device may adjust the set of response tasks. The server may then receive this adjusted set and output it to the user(s).

As a general aspect, any of the functions discussed herein with respect to a central computer device may also be provided by user-bound devices that a user directly interacts with. This particularly relates to analysing the freely formulated response, eg due to storing a respective model as discussed below directly on user-bound devices. Such a model may eg be included in a software application that is downloaded to said user-bound devices. The analysis result may then be communicated to the central computer device. On the other hand, the user-bound devices may directly use these analysis results to perform any of the adjustments of the initial set of response task discussed herein. Preferably, however, responses to the adjusted set of response tasks are provided to a central computer device which preferably analyses responses received from a large number of users in a centralised manner.

By shifting functions to user-bound devices, resource usage of the computer network and in particular a communication network comprised thereby can be reduced. Additionally or alternatively, the general reaction time and thus interaction speed with a user can be increased due to a reduced risk of delays that might occur when frequently communicating back and forth with a central computer device.

The term “central” with respect to the central computer device may be understood in a functional or hierarchical manner, but not necessarily in a geographical manner. As noted above, as respective centralised functions the central computer device may define or forward the initial set of predetermined response tasks and/or may analyse the free-formulation response task and/or may adjust the set of predetermined response tasks. It may output the initial and/or adjusted response tasks to user-bound computer devices or to a server connected to said user-bound computer devices. The user-bound computer devices may be mobile end devices, smartphones, tablets or personal computers. User-bound computer devices may be computer devices which are under direct user control, eg by directly receiving inputs from the user via dedicated input means.

Also, the central computing unit may receive eg the freely formulated responses from said userbound computer devices. The user-bound computer devices and the central computer device may thus define at least part of the computer network. Yet, they may be located remotely from one another.

The user-bound computer devices may, for performing the solution disclosed herein, eg access or connect to a webpage and/or a software program that is run on the central computer device and/or to a server, thereby eg accessing the online platform discussed herein. Such accesses may enable the data exchanges between the computer devices discussed herein.

When being connected to a communication network and in particular to the online platform, a computer device may be referred to as being online and/or a data exchange of said computer device may be referred to as taking place in an online manner. The communication links may be part of a communication network. They may be or comprise a WLAN communication network. In general, the communication network may be internet-based and/or enable a communication between at least the (user-bound) computer devices and a central computer device via the internet.

The central computer device may be located remotely from the organisation and may eg be associated with a service provider, such as a consultancy, that has been appointed to gather the evaluation information.

The response tasks of the initial set may be predetermined in that they should theoretically be provided to a user in full (ie as a complete set) and/or in that their contents and/or response options are predetermined. The response tasks may be datasets or may be part of a dataset. A response task can equally be referred to as a feedback task prompting a user to provide feedback.

For example, each response task may comprise text information (eg text data) formulating a task for prompting the user to provide a response. For example, the text information may ask the user a distinct question and/or may prompt the user to provide a feedback on a certain topic. The response may then be provided by the user selecting one of the predetermined (ie available and prefixed) response options.

Accordingly, the response options may be selectable response options, the selection being performed eg based on a user input. For example, each response task may be associated with at least two response options and a response to the response task may the defined by the user selecting one of these response options.

The response options may be selectable values along a scale (eg a numeric scale). Each selectable value along said scale may represent a single response option. Likewise, the response options may be numbers, words or letters that can be entered into eg a text field and/or by using a keyboard. However, an inputted text may only be valid and accepted as a response if it conforms to an expected (eg valid) response option that may be stored in a database. Thus, the overall response options may again be limited and/or pre-structured or predetermined.

Additionally or alternatively, the response options may be statements or options that the user can select as a response to a response task. Additionally or alternatively, absolute question types may be included in which a respondent directly evaluates a certain aspect eg by quantifying it and/or setting a (perceived) level thereof. A response option may then be represented by each level that can be set or each value that can be provided as a quantification.

For example, a response task may ask a user to select one out of a plurality of options as the most important one, wherein each option is labelled by and/or described as a text. The response options may then be represented by each option and/or label that can be selected (eg by a mouse click).

An advantage of providing predetermined response options is that the subsequent data analysis can be comparatively simple. For example, each response option may be directly associated or linked with a value of an evaluation score. Thus, when being selected, said score can be directly derived without extensive analyses or computations.

On the other hand, a disadvantage may be seen in that for evaluating each characteristic of interest, dedicated response tasks along with dedicated response options have to be provided for each respective characteristic. As previously noted, this may lead to long and data-intensive procedures, in particular when trying to achieve statistically significant results.

To the contrary, the solution disclosed herein may help to limit the number of dedicated response tasks and response options by, as a preferably initial measure, using the freely formulated response to cancel out those response tasks and/or response options associated with characteristics of interests for which sufficient information have already been provided by said freely formulated response.

A response task may generally be output in form of audio signals, as visual signals/information (eg via at least one computer screen) and/or as text information.

The characteristic of interest may be a certain aspect, such as a characteristic of an organisation.

For example, the characteristic may be a predetermined mindset or behavior that is observable within the organisation. The evaluation may relate to the importance and/or presence of said mindset or behavior within the organisation from the employees' perspective. Thus, the method may be directed at generating evaluation scores for each mindset or behavior from the employees' perspective to eg determine which of the mindsets and behaviors are sufficiently present within the organisation and which should be further improved and encouraged.

Identifying the evaluation information may include analysing the freely formulated response or any information derived therefrom. For example, the freely formulated response may be at first provided in form of a speech input and/or audio recording which may then be converted into a text.

Both, the original input as well as a conversion (in particular into text) may in the context of this disclosure be considered as examples of a freely formulated response. For this conversion, known speech-to-text algorithms can be employed. The text can then be analysed to identify the evaluation information.

The identification may include identifying keywords, keyword combinations and/or key phrases within the freely formulated response. For doing so, comparisons of the freely formulated response to prestored information and in particular to prestored keywords, keyword combinations or key phrases as eg gathered from a database may be performed.

Said prestored information may be associated or, differently put, linked with at least one characteristic to be evaluated (and in particular with evaluation scores thereof), this association/link being preferably prestored as well.

Additionally or alternatively, a computer model and in particular a machine learning model may be used which may preferably comprise an artificial neural network. This will be discussed in further detail below. This computer model may model an input-output-relation, eg defining how contents of the freely formulated response and/or determined meanings thereof translate into evaluation scores for characteristics of interest.

Also, the identification of evaluation information from the freely formulated response may include at least partially analysing a semantic content of the freely formulated response and/or an overall context of said response in which eg an identified meaning or key phrase is detected. Again, this may be performed based on known speech/text analysis algorithms and/or with help of the computer model.

Specifically, the above-mentioned computer model and in particular machine learning model may be used for this purpose. Said model may receive the freely formulated response or at least words or word combinations thereof as input parameters and may eg output an identified meaning and/or identified evaluation information. In a known manner, it may also receive n-grams and/or outputs of so-called Word2Vec algorithms as an input. Generally put, the model may receive analysis results of the freely formulated response (eg identified meanings) determined by known analysis algorithms and use those as inputs or may include such algorithms for computing respective inputs. The model may (eg based on verified training data) define, how such inputs (ie specific values thereof) are linked to evaluation information.

As an example, the model may eg be determined whether an identified keyword is mentioned in a positive or negative context. This may be employed to evaluate the associated characteristic accordingly, eg by setting an evaluation score for said characteristic to a respectively high or low value.

In this context, employing a computer model and in particular machine learning model may have the further advantage of an identified context and/a semantic content being converted into respective evaluation scores in a more precise and in particular more refined manner compared to performing one-by-one keyword comparisons with a prestored database.

For example, the computer model may be able to model and/or define more complex or more (nonlinear) interrelations between contents of the freely formulated response and the evaluation scores for characteristics of interests. This may relate in particular to determining, whether a certain keyword or keyword combination is mentioned in a positive or negative manner within said response. For example, the model may be able to also consider that the presence of further other keywords within said response may indicate a positive or negative context.

For such a computer model, no comparisons to prestored information which exactly describe the above relations may have to be provided, but the model may include or define (eg mathematical) links, rules, associations or the like that have eg been trained and defined during a machine learning process. In consequence, even if keyword combinations are provided that are as such unknown to the model (ie have not been part of a training dataset and are not contained in any prestored information), the model may still be able to compute a resulting evaluation score due to the general links and/or mathematical relations defined therein.

In general, for evaluating a characteristic, several responses and/or selections of response options may have to be gathered from each user, each producing evaluation information for evaluating said characteristic. That is, a plurality of response tasks may be provided that are directed to evaluating the same characteristic.

An evaluation and in particular an evaluation information may represent and/or include a score or a value, such as an evaluation score discussed herein. The total amount and/or number of evaluation information (eg the total amount of selections) from one user and preferably from a number of users may then be used to determine a final overall evaluation of said characteristic. For example, a mean value of evaluation scores gathered via various response tasks and/or response options from one or more user(s) may be computed. In this context, the evaluation scores may each represent one evaluation information and are preferably directed to evaluating the same characteristic. On the other hand, at least on a single user level it may equally be possible to only provide one evaluation information and/or one evaluation score for each characteristic to be evaluated. An overall evaluation score for the characteristic may then be computed based on said single evaluation information derived from each of a number of users.

The adjustment of the set of predetermined response tasks may be performed at least partially automatic but preferably fully automatic. For doing so, a computer device of the computer network and in particular the central computer device may perform the respective adjustment based on the result of the identification or, more generally, based on the analysis result of the freely formulated response.

For doing so, it may be determined for which characteristics evaluation information have already been gathered via said freely formulated response. Differently put, it may be determined which characteristic has already been at least partially, sufficiently and/or fully evaluated with said evaluation information. For example, it may be determined whether sufficient evaluation information have been gathered from a statistical point of view to, eg with a desired statistical certainty, evaluate the characteristic of interest.

Then, it may be determined which response tasks (eg of the initial set of predetermined response tasks) and/or which response options of said response tasks are directed to gathering evaluation information for the same purpose and in particular for evaluating the same characteristic. If it has been determined that sufficient evaluation information for said characteristic have been gathered (eg a minimum amount of evaluation scores), response tasks and/or response options included in said initial set may be removed from the initial set and/or may not be included in the adjusted set.

Thus, it may be avoided that more evaluation information than actually needed are gathered.

This renders the overall method more efficient and eg limits the data amount to be communicated and/or processed within the computer network.

Accordingly, the preferably automatic adjustment may include the above discussed automatic determination of removable or, differently put, omissible response tasks and/or response options.

Also, this adjustment may include the respective automatic removal or omission as such.

Outputting the adjusted set of predetermined response tasks may include communicating the adjusted set from eg a central computer device to user-bound computer devices of the computer network. Thus, the adjusted set of response tasks may generally be output by at least one computer device of said computer network. Again, this set may be output via at least one computer screen of said user-bound computer device. The adjusted set of predetermined responses may then be answered by the user similar to known online surveys and/or online questionnaires. This way, any missing evaluation information that have not been identified from the freely formulated response may be gathered for evaluating the one or more characteristics of interest.

As previously mentioned, the freely formulated response may be a text response and/or a speech response and/or a behavioral characteristics of the respondent, eg when providing the speech or text response or when interacting with an augmented reality scenario. The computer device may thus include a microphone and/or a text input device and/or a camera. It may also be possible that a speech input is directly converted into a text eg by a user-bound computer device and that the user may then complete or correct this text which then makes up the freely formulated response.

This is an example of a combined text-and-speech-response which may represent the freely formulated response.

In one embodiment, the freely formulated response may at least partially be based on or provided alongside with an observed behavior, eg in an augmented reality environment. For example, the user may be asked to provide a response by engaging in an augmented reality scenario that may eg simulate a situation of interest (eg interacting with a client, a superior or a team of colleagues). Responses may be given in form of and/or may be accompanied with actions of the user. Said actions may be marked by certain behavioral patterns and/or behavioral characteristics which may be detected by a computer device of the computer network (eg with help of camera data). Such detections may serve as additional information accompanying eg speech information as part of the freely formulated response or may represent at least part of said response as such.

They may eg be used as input parameters of a model to determine evaluation information.

Behavioral characteristics may eg be a location of a user, a body posture, a gesture or a velocity eg of reacting to certain events.

Moreover, as previously mentioned, the free-formulation response task may ask and/or prompt the user to provide feedback on a certain topic. This topic may be the characteristic to be evaluated.

As likewise mentioned, according to an embodiment, generating the adjusted set may include adjusting the initial set of predetermined response tasks, eg by reducing the number of response tasks and/or response options. In this context, those response tasks and/or response options may be removed which are provided to gather evaluation information which have already been identified based on the freely formulated text response.

Additionally or alternatively, adjusting the set of predetermined response task may include selecting certain of the response tasks from an initial set and making up (or, differently put, composing) the adjusted set of predetermined response tasks based thereon. Generally, it is also conceivable to adjust the set of predetermined response tasks by defining a sequence of the response tasks according to which these are output to the user. Response tasks directed to gathering evaluation information which have been derived from the freely formulated response may be placed in earlier positions according to said sequence. This may increase the quality of the received results since users tend to be more focused during early stages of eg an online survey.

Generally, any of the following adjustments or reactions to the freely formulated response and in particular to its analysed contents (alone or in any combination) are conceivable, apart from the ones mentioned above:—In case the freely formulated response contains evaluation information for a characteristic of interest, response tasks directed to said characteristic may be omitted;—In case the freely formulated response contains information not related to any characteristic of interest, this may be signalled to eg a system administrator. Such information may represent a new topic. In case similar new topics occur throughout a larger number of freely formulated responses from a number of users, this may prompt the system administrator to include predetermined response tasks specifically directed to said topic/characteristic; In case the freely formulated response contains evaluation information for a characteristic of interest, response tasks related to similar characteristics may be output first in a subsequent stage. Differently put, a need for providing certain follow-up question may be determined which focus on the same or a related topic/characteristic.

In one development, the identification of evaluation information based on the freely formulated response (eg the analysis of said freely formulated response) is performed with a computer model that has been generated (eg trained) based on machine learning. In general, for generating the computer model a supervised machine learning task may be performed and/or a supervised regression model may be developed as the computer model. Generating the model may be part of the present solution and may in particular represent a dedicated method step. From the type or class and in particular the program code, a skilled person can determine whether such a model has been generated based on machine learning. Note that generating a machine learning model may include and/or may be equivalent to training the model based on training data until a desired characteristic thereof (eg a prediction accuracy) is achieved.

Generally, the model may be computer implemented and thus may be referred to as a computer model herein. It may be included in or define a software module and/or an algorithm in order to, based on the freely formulated response, determine evaluation information contained therein or associated therewith. Generating the model may be part of the disclosed solution. Yet, it may also be possible to use a previously trained and/or generated model.

The model may, eg based on a provided training dataset, express a relation or link between contents of the freely formulated response and evaluation information and/or at least one characteristic to be evaluated. It may thus define a preferably non-linear input-output-relation in terms of how the freely formulated response at an input side translates eg into evaluation information and in particular evaluation scores for one or more characteristics at an output side.

The training dataset may include freely formulated responses eg gathered during personal interviews. Also, the training dataset may include evaluation information that have eg been manually determined by experts from said freely formulated responses. Thus, the training dataset may act as an example or reference on how freely formulated responses translate into evaluation information. This may be used to, by machine learning processes, define the links and/or relations within the computer model for describing the input-output-relation represented by said model.

Specifically, the model may define weighted links and relations between input information and output information. In the context of a machine learning process, these links may be set (eg by defining which input information are linked to which output information). Also, the weights of these links may be set. In a generally known manner, the model may include a plurality of nodes or layers in between an input side and an output side, these layers or nodes being linked to one another. Thus, the number of links and their weights can be relatively high, which, in turn, increases the precision by which the model models the respective input-output-relation.

The machine learning process may be a so-called deep learning or hierarchical learning process, wherein it is assumed that numerous layers or stages exist according to which input parameters impact output parameters. As part of the machine learning process, links or connections between said layers or stages as well as their significance (ie weights) can be identified.

Similarly, a neural network representing or being comprised by a computer model and which may result from a machine learning process according to any of the above examples, may be a deep neural network including numerous intermediate layers or stages. Note that these layers or stages may also be referred to as hidden layers or stages, which connect an input side to an output side of the model, in particular to perform a non-linear input data processing. During a machine learning process, the relations or links between such layers and stages can be learned or, differently put, trained and/or tested according to known standard procedures. As an alternative to neural networks, other machine learning techniques could be used.

Thus, as mentioned, the computer model may be an artificial neural network (also only referred to as neural network herein). The machine learning process may be a so-called deep learning or hierarchical learning process, wherein it is assumed that numerous layers or stages exist according to which input information impact output information. As part of the machine learning process, links or connections between said layers or stages as well as their significance (ie weights) might be identified.

In sum, according to a further embodiment, the computer model determines and/or defines a relation between contents of the freely formulated response and evaluation information for the at least one characteristic. Thus, based on the freely formulated response the model may compute respective evaluation information and in particular an evaluation score for said characteristic. On the other hand, it may also determine that no evaluation information of a certain type or for certain characteristic are contained in the freely formulated response. This may be indicated by setting an evaluation score for said characteristic to a respective predetermined value (eg zero).

According to one embodiment, by means of the computer model, an evaluation score is computed, indicating how the characteristic is evaluated. The evaluation score may be positive or negative.

Alternatively, it may be defined along an eg only positive scale wherein the absolute value along said scale indicates whether a positive or negative evaluation is present (eg above a certain threshold, such as 50, the evaluation score may be defined as being positive). Alternatively, the evaluation score may indicate a certain level (eg a level of importance, a level of a characteristic being perceived to be present/established, a level of a statement being considered to be true or false, and so on). By means of the evaluation score and in particular the model directly determining and outputting such an evaluation score, the analysis of the gathered responses can be conducted efficiently and reliably.

Moreover, a confidence score may be computed by means of the computer model, said confidence score indicating a confidence level of the computed evaluation score. The confidence score may be determined eg by the model itself. For example, the model may eg depending on the weights of links and/or confidence information associated with certain links determine, whether a inputoutput relation and that the resulting evaluation score is based on a sufficient level of confidence and eg based on a sufficient amount of considered training data. Evaluation scores that have been determined by means of links with comparatively low weights may receive lower confidence scores than evaluation scores that have been determined by means of high-weighted links.

Additionally or alternatively, known techniques for how machine learning models evaluate their predictions in terms of an expected accuracy (ie confidence) may be used to determine a confidence score. For example, a probabilistic classification may be employed and/or an analysed freely formulated response (or inputs derived therefrom) may be slightly altered and again provided to the model. In the latter case, if the model outputs a similar prediction/evaluation information, the confidence may be respectively high. Thus, the confidence score may be determined based on the output of a computer model which is repeatedly provided with slightly altered inputs derived from the same freely formulated response.

Additionally or alternatively, the confidence score may be determined based on the length of a received response (the longer, the more confident), based on identified meanings and/or semantic contents of a received response, in particular when relating to the certainty of a statement (eg “It is . . . ” being more certain than “I believe it is . . . ”), and/or based on a consistency of information within a user's response. For example, in case the user provides contradicting statements within his response, the confidence score may be set to a respectively lower value.

Generally, when using a computer model for analysing the freely formulated response, said computer model may have been trained based on training data. These data may be historic data indicating actually observed and/or verified relations between freely formulated responses and evaluation information contained therein. This may result in the confidence score being higher, the higher the similarity of a freely formulated response to said historic data.

According to a further example and as mentioned above, the computer model may comprise an artificial neural network.

In a further aspect, a completeness score may be computed (eg by a computer device of the computer network and in particular a central computer device thereof), said completeness score indicating a level of completeness of the gathered evaluation information, eg compared to a desired completeness level. The completeness score may indicate whether or not a sufficient amount or number of evaluation information and eg evaluation scores have been gathered for evaluating at least one characteristic of interest. Preferably, for each characteristic, a respective completeness score may be gathered.

Also, it may indicate whether a desired statistical level and in particular statistical certainty has been achieved, eg based on a distribution of the evaluation scores received so far for evaluating a certain characteristic. That is, a statistic confidence level may be determined with regard to the distribution of all evaluation scores for evaluating a certain characteristic.

The confidence level may be different from the confidence score noted above which describes a confidence with regard to the input-output-relation determined by the model (ie an accuracy of an identification performed thereby). Specifically, this confidence level may describe a confidence level in terms of a statistical significance and/or statistic reliability of a determined overall evaluation of the at least one characteristic of interest.

For doing so, it is preferred to consider the evaluation information received for said characteristic from all users and, differently put, across all respondents. These evaluation information may then define a statistical distribution (of eg evaluation scores for said characteristic) and this distribution may be analysed in statistical terms to determine the completeness score. For example, if said distribution indicates a standard deviation below of an acceptable threshold, the completeness may be set to a respectively low and in particular to an acceptable value.

Additionally or alternatively, the completeness score may be calculated across a population of respondents. It may indicate the degree to which a certain topic and in particular a characteristic of interest has already been covered by said respondents. If the completeness score is above a desired threshold, it may be determined that further respondents may not have to answer response tasks directed to the same or a similar characteristic. The free formulation response task and/or initial set of response tasks for these further respondents may be adjusted accordingly upfront.

The invention also relates to a computer network for gathering evaluation information for at least one predetermined characteristic from preferably a plurality of users, wherein the computer network has (eg by accessing, storing and/or defining it) an initial set of predetermined response tasks, each response task comprising a number of predetermined response options, wherein based on the response options selected by a user, evaluation information for evaluating at least one predetermined characteristic are gathered or determined; wherein the computer network comprises at least one processing unit that is configured to execute the following software modules, stored in a data storage unit of the computer network:
a free-formulation output software module that is configured to provide, generate and/or output at least one free-formulation response task by means of which a freely formulated response can be received from at least one user, preferably wherein said pre-formulation response task does not include predetermined response options;
a free-formulation analysis software module that is configured to analyse the freely formulated response and to thereby identify evaluation information contained therein, said evaluation information being usable for evaluating the at least one predetermined characteristic;
a response set adjusting software module is configured generate an adjusted set of response tasks based on the evaluation information identified by the free-formulation analysis software module.

A software module may be equivalent to a software component, software unit or software application. The software modules may be comprised by one software program that is eg run on the processing unit. Generally, at least some and preferably each of the above software modules may be executed by a processing unit of a central computer devices discussed herein. Also, any further software modules may be included for providing any of method steps disclosed herein and/or for providing any of the functions or interactions of said method.

For example, a free-formulation gathering software module may be provided which is configured to gather a freely formulated response in reaction to the free-formulation response task. This software module may be executed by a user-bound computer device and may then communicate the freely formulated response to eg the free-formulation analysis software module.

Generally, the computer network may be configured to perform any of the steps and to provide any functions and/or interactions according to any of the above and below aspects and in particular according to any of the method aspects disclosed herein. Thus, the computer network may be configured to perform a method according to any embodiment of this invention. For doing so, it may provide any further features, further software modules or further functional units needed to eg perform any of the method steps disclosed herein. Also, any of the above and below discussions and explanations of method-features and in particular their developments or variants may equally apply to the similar features of the computer network.

The invention will be further discussed with respect to the attached schematic drawings. Similar features may be labelled with similar reference signs throughout the figures.

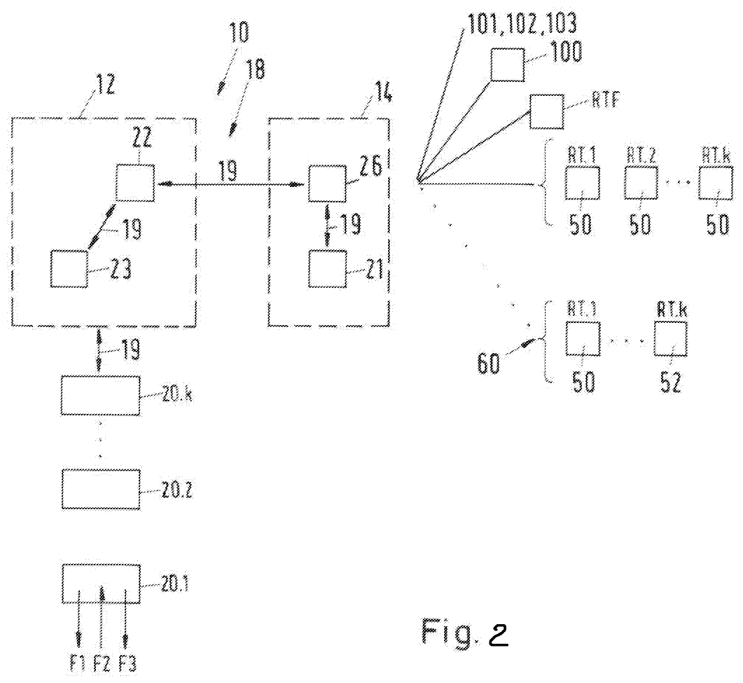

FIG. 2

FIG. 2 is an overview of a computer network 10 according to an embodiment of the invention, said computer network 10 being generally configured (but not limited) to carrying out the method described in the following. The computer network 10 comprises a plurality of computer devices 12, 21, 20.1-20.k, which are each connected to a communication network 18 comprising several communication links 19.

As will be discussed in the following, the computer devices 20.1-20.k are end devices under direct user control (ie are user-bound devices, such as mobile terminal devices and in particular smartphones); preferably, the end devices comprise a human-computer interface which behaves according to a personal profile of a human respondent. The computer device 12 is a server which provides an online platform that is accessible by the user-bound computer devices 20.1-20.k. The computer device 21 provides an analysing capability, in particular with regard to freely-formulated responses provided by a user.

However, this capability may also be implemented in the user-bound computer devices 20.1-20.k which could equally comprise a model 100 are discussed below.

In the shown example, the computer network 10 is implemented in an organisation, such as a company, and the users are members of said organisation, eg employees. The computer serves to implement a method discussed below and by means of which evaluations of characteristics of interest with respect to the company can be gathered from the employees. This may be done in form of an online survey conducted with help of a server 12. Specifically, this survey may help to better understand a current state of the company and in particular to identify potentials for improvement based on gathered evaluation information.

In more detail, the computer network 10 comprises a server 12. The server 12 is connected to the plurality of computer devices 20.1-20.k and provides an online platform that is accessible via said computer devices 20.1-20.k. For providing said online platform and in particular the functions and interactions discussed below, the server 12 comprises a data processing unit 23, eg comprising at least one microprocessor. The server 12 further comprises data storing means in form of a database system 22 for storing below-discussed data but also program instructions, eg for providing the online platform.

Moreover, a so-called analysis part 14, preferably an interrogator according to the invention, is provided which may also be referred to as a brain to reflect its data analysing capability. Preferably, the analysis part 14 and/or the server 12 are located remotely from the organisation, eg in a computational center of a service provider that implements the method disclosed herein.

The analysis part 14 comprises a database 26 (brain database 26) as well as a central computer device 21. The term “central” expresses the relevance of said computer device 21 with regard to the data processing and in particular data analysis.

In general, the computer devices 20.1-20.k are used to interact with the organisation's members and are at least partially provided within the organisation. Specifically, the computer devices 20.1-20.k may be PCs or smartphones, each associated with and/or accessible by an individual member of the organisation. It is, however, also possible that several members share one computer device 20.1-20.k. The central computer device 21, on the other hand, is mainly used for a computer model generation and for analysing in particular a freely formulated response. Accordingly, it may not be directly accessible by the organisation's members but eg only by a system administrator.

As noted above, the computer network 16 further comprises a preferably wireless (eg electrical and/or digital) communication network 18 to which the computer devices 20.1-20.k, 21 but also the databases 22, 26 are connected. The communication network 18 is made up of a plurality communication links 19 that are indicated by arrows in FIG. 2. Note that such links 19 may also be internally provided within the server 12 and the analysis part 14.

In FIG. 2, one selected computer device 20.1 is specifically illustrated in terms of different functions F1-F3 associated therewith or, more precisely, associated with the online platform that is accessible via said computer device 20.1. Each function F1-F3 may be provided by means of a respective software module or software function of the online platform and may be executed by the processing unit 21 of the server 12 and/or at least partially by a non-illustrated processing unit of the user-bound computer devices 20.1-20.k. The functions F1-F3 form part of a front end with which a user directly interacts.

As will be detailed below, function F1 relates to outputting a free formulation response task to a user, function F2 relates to receiving a freely formulated response from the user in reaction said response task and function F3 relates to outputting an adjusted set of response tasks to the user.

A further non-specifically illustrated function is to then receive inputs from the user in reaction to said adjusted set of response tasks.

It is to be understood that any aspects discussed with respect to the computer device 20.1 equally applies to the further computer devices 20.2-20.k. In particular, each further computer device 20.2-20.k provides equivalent functions F1-F3 and enables at least one of the organisation's members to interact with said functions F1-F3. This way, responses can be gathered from a large number of in particular several hundreds of users.

For interacting with a computer device 20.1-20.k and in particular for inputting information, a user may use any suitable input device or input method, such as a keyboard, a mouse, a touchscreen but also voice commands.

Further, a database system 22 of the server 12 is shown. The database system 22 may comprise several databases, which are optimised for providing different functions. For example, in a generally known manner, a so-called live or operational database may be provided that directly interacts with the front end and/or is used for carrying out the functions F1-F3. Also, a so-called data warehouse may be provided which is used for long-term data storage in a preferred format. Data from the life database can be transferred to the data warehouse and vice versa via a so-called ETLtransfer (Extract, Transformation, Load).

The database system 22 is connected to each of the computer devices 20.1-20.k (eg via the server 12) as well as to the analysis part 14 and specifically to its brain database 26 via communication links 19 of the electronic communication network 18. As indicated by a respective double arrow in FIG. 2, data may also be transferred back from the analysis part 14 (and in particular from the brain database 26) to the server 12. Said data may eg include an adjusted set of predetermined response tasks generated by the central computer device 21.

Note that the functional separation between the server 12 and analysis part 14 in FIG. 2 is only of by way of example. According to this invention, it is equally possible to only provide one of the server 12 and analysis part 14 and implement all functions discussed herein in connection with the server 12 and analysis part 14 into said provided single unit. For example, the central computer device 21 could be designed to provide all respective functions of the server 12 as well.

To begin with, a schematically illustrated initial set of response tasks RT.1, RT.2 . . . RT.K is stored in the brain database 26. Each response task RT.1, RT.2 . . . RT.K may be provided as a dataset or as a software module. The response tasks RT.1, RT.2 . . . RT.K are predetermined with regard to their contents and they are selectable response options 50 and preferably also with regard to their sequence.

Each response task RT.1, RT.2 . . . RT.K preferably includes at least two response options 50 of the types exemplified in the general part of this disclosure. The response options 50 are predetermined in that only certain inputs can be made and in particular only certain selections from a predetermined range of theoretically possible inputs our possible.

Due to the initial set of response tasks RT.1, RT.2 . . . RT.K being predetermined in the discussed manner, said response tasks RT.1, RT.2 . . . RT.K and/or the initial set as such may be referred to as being structured. That is, the range of receivable inputs is limited due to the predetermined response options 50, so that a fixed underlying structure or, more generally, a fixed and thus structured expected value range exists.

Note that the brain database 26 also comprises software modules 101-103 by means of which the central computing device 21 can provide the function discussed herein. The software modules are the previously mentioned free-formulation output software module 101, the free-formulation output software module 102 and the response set adjusting software module 103. Any of these modules (alone or in any combination) may equally be provided on a user-level (ie may be implemented on the respective user-bound devices 20.1 . . . 20.k).

Furthermore, the brain database 26 comprises a free-formulation response task RTF. Said freeformulation response task RTF is free of predetermined response options 50 or only defines the type of data that can be input and/or the type of input method, such as and input via speech or text.

The free-formulation response task RTF prompts a user to provide feedback on a certain topic of interest, said topic being or at least indirectly linked to at least one characteristic to be evaluated.

Both of the free-formulation response task RTF and the initial set of response tasks RT.1, RT.2, RT.k may be exchangeable, eg by a system administrator, but not necessarily by the users/employees.

As will be discussed in further detail below, as an initial step, the free-formulation response task RTF is output to a user (function F1) eg by transferring said free-formulation response tasks RTF from the brain database 26 to the database system 22 of the server 12. Based on this free formulation response task RTF, a freely formulated (or unstructured) response is received (function F2) and this response is eg transferred back from the server 12 to the brain database 26. Following that, the central computer 21 performs an analysis of the freely formulated response with help of a computer model 100 (also referred to as model 100 in the following) stored in the brain database 26 and discussed in further detail below.

Based on the analysis result, an adjusted set 60 of response tasks RT.1 . . . RT.K is generated, again preferably by the central computer device 21 and preferably stored in the brain database 26.

In the shown example, this adjustment takes place by removing at least some of the response tasks from the initial set (cf. the response task RT.2 of the initial set not being included in the adjusted set 60). Additionally, the number of response options 50 may be changed and/or different response options 52 may be provided (see response options 50, 52 of response task RT.k of the initial set compared to the adjusted set 60).

The adjusted set 60 is then again transferred to the server 12 and output to the users according to function F3. Following that, evaluation information are gathered from the users which answer the response tasks RT.1 . . . RT.k of this adjusted set 60. These evaluation information may be transferred to the brain database 26 and further processed by the computing device 21, eg to derive an overall evaluation result and/or to compute the completeness score discussed below.

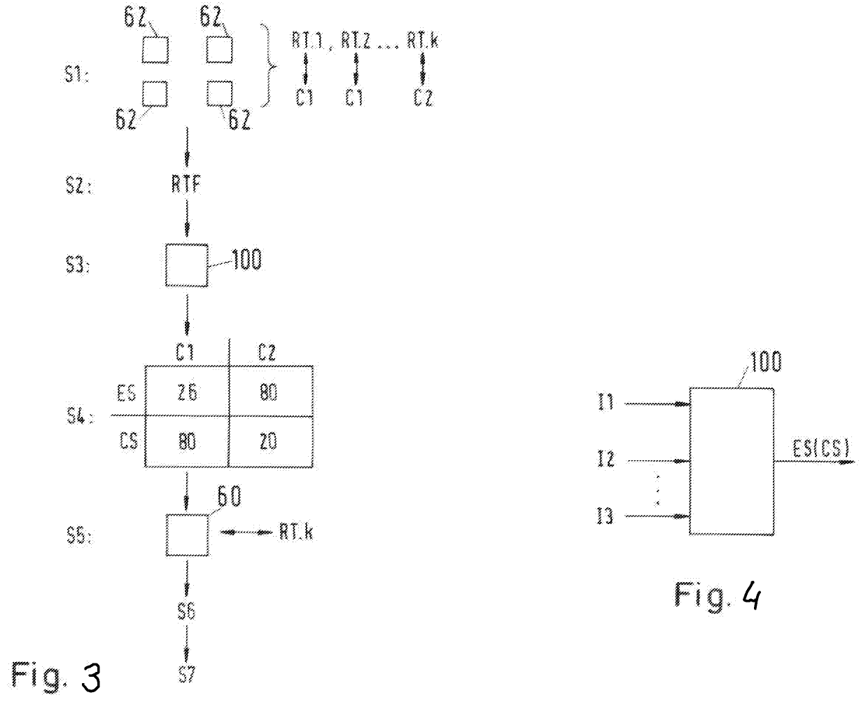

FIG. 3 shows a flow diagram of a method that may be carried out by the computer network 10 of FIG. 2. The following discussion may in part focus on an interaction with only one user. Yet, it is apparent that a large number of users are considered via their respective computer devices 20.1-20.k. Each user may thus perform the following interactions and this may be done in an asynchronous manner, eg whenever a user finds the time to access the online platform of the server 12.

As a general aspect, it is shown that the initial set of response tasks RT.1, RT.2, RT.k is subdivided into a number of subsets or modules 62. As noted below, the modules 62 can further be subdivided into topics by grouping response tasks RT.1, RT.2, RT.k included therein according to certain topics. In a step S1, this overall initial set is received, eg by being defined by a system administrator and/or by generally being read out from the system database 26 and preferably being transferred to the server 12.

Each response task RT.1, RT.2, RT.k is associated with at least one characteristic C1, C2 for which evaluation information shall be gathered by the responses provided to said response tasks RT.1, RT.2, RT.k. The evaluation information may be equivalent to and/or may be based on response options 50, 52 selected by a user when faced with a response task RT.1, RT.2, RT.k.

Note that in the shown example, different response tasks RT.1, RT.2 may be used for evaluating the same characteristic C1. This is, for example, the case when a number of evaluation information and in particular evaluation scores are to be gathered for evaluating the same characteristic C1 and, in particular, for deriving a statistically significant and reliable evaluation of said characteristic C1.

In the shown example, the characteristics C1, C2 may relate to predetermined aspects which have been identified as potentially improving the organisation's performance or potentially acting as obstacles to achieving a sufficient performance (eg if not being fulfilled). The characteristics C1, C2 may also be referred to or represent mindsets and/or behaviors existing within the organisation's culture. By way of the evaluation information gathered by each response task RT.1, RT.2, RT.k and from each user, evaluation scores may be computed as discussed in the following which eg indicate whether a respective characteristic C1, C2 is perceived to be sufficiently present (positive and/or high score) or is perceived to be insufficiently present (negative and/or low score).

In a step S2 the free-formulation response task RTF is received and in a similar manner. Following that, it is output to a user whenever he accesses the online platform provided by the server 12 to conduct an online survey. The user is thus prompted to provide a freely formulated response.

As an optional measure which is not specifically indicated in FIG. 3, an initial step (eg a nonillustrated step S0) can be provided in which a common understanding in preparation of the freeformulation response task RTF is established. This may also be referred to as an anchoring of eg the user with regard to said response task RTF and/or the topic or characteristic C1, C2 concerned.

Specifically, text information, video information and/or audio information for establishing a common understanding of a topic on which feedback shall be provided by means of the pre-formulation response task RTF may be output to the user. In the shown example, this may be a definition of the term “performance” and what the performance of an organisation is about.

Following that, as a general example, the free-formulation response task RTF may ask the user to provide his opinion on what measure should best be implemented, so that the organisation can improve its performance. The user may then response eg by speech which is converted into text by any of the computer devices 20.1, 20.2, 20.K, 12, 21 of FIG. 2.

This response may eg be as follows “I want disruptors, start up and innovators who can bring new thinking into the organisation.

If we want to continue success and growth strategy we need people to challenge the status quo”.

In a step S3, the converted text (which is equally considered to represent the freely formulated response herein, even though said response might have originally been input by speech) is analysed with help of the model 100 indicated in FIG. 2.

The model 100 determines evaluation information contained in the freely formulated response.

Specifically, the model 100 is a computer model generated by machine learning and, in the shown case, is an artificial neural network. It analyses the freely formulated response with regard to which words are used therein and in particular in which combinations. Such information are provided at an input side of the model 100. At an output side, evaluation scores for the characteristics C1, C2 are output, said scores been derived from the freely formulated response. Possible inner workings and designs of this model 100 (ie how the information at the input side are linked to the output side) are discussed in the general specification and are further elaborated upon below.

In a step S4, the central computing device 21 checks for which characteristics C1, C2 (the total number of which may be arbitrary) evaluation scores have already been gathered. This is indicated in FIG. 3 by a table with random evaluation scores ES from an absolute range of zero (low) to 100 (high) for the exemplary characteristics C1, C2.

Likewise, confidence scores CS are determined for each characteristic C1, C2. These indicate a level of confidence with regard to the determined evaluation score ES, eg whether this evaluation score ES is actually representative and/or statistically significant. They thus express a subjective certainty and/or accuracy of the model 100 with regard to the evaluation score ES determined thereby. These confidence scores CS may equally be computed by the model 100 eg due to being trained based on historic data as discussed above.

It is then determined, for which characteristics C1, C2 evaluation information in form of the evaluation scores ES have already been provided and in particular whether these evaluation information have sufficiently high confidence scores CS. This is done in step S5 to generate the adjusted set 60 of response tasks RT.1, RT.k based on the criteria discussed so far and further elaborated upon below.

For example, it may be determined that the evaluation score ES for the characteristics C1 of FIG. 3 is rather low (which is generally not a problem), but that the confidence score CS is rather high (80 out of 100). If the confidence score CS is above a predetermined threshold (of eg 75), it may be determined that sufficient evaluation information have already been provided for the associated characteristic C1. Thus, the response tasks RT.1, RT.2 that are designed to gather evaluation information for said characteristic C1 may not be part of the adjusted set 60. Instead, said set 60 may only comprise the response task RT.k since the characteristics C2 associated therewith is marked by a rather low confidence score CS.

Differently put, from the freely formulated response, only insufficient evaluation information could be identified for the characteristics C2. Thus, the user should be confronted with the response task RT.k that is specifically directed to gathering evaluation information for this characteristic C2 in the final step S6.

Note that as a general aspect of this invention which is not bound to the further details of the embodiments, adjusting the set of response task may be performed on a user-level (ie each user receiving an individually adjusted set of response task based on his freely formulated response).

In step S6, the adjusted set of response tasks is output to the user which then performs a standard procedure of answering the response tasks of said set by selecting response options 50, 52 included therein. This way, further evaluation scores are gathered for at least remaining insufficiently evaluated characteristics of interest. Updating the evaluation scores ES but also possibly the confidence scores CS for said characteristic C1, C2 based on the responses to the adjusted set 60 is preferably done by the central computer device 21. The survey may be finished when all response tasks of the adjusted set 60 have been answered. Yet, the method may then continue to determine a completeness score discussed below by considering evaluation information across a plurality of and in particular all users.

Note that in particular steps S5 and step S6 have only been described with reference to one user.

It is generally preferred to consider responses gathered from a plurality of users in a concurrent or asynchronous manner in these steps S5, S6.

As a further optional feature, a completeness score may be computed. This is preferably done in a step S7 and based on the users' answers to the adjusted sets 60 of response tasks RT.1, RT.2, RT.k. Accordingly, the completeness score is preferably determined based on evaluation information gathered from a number of users.

The completeness score may be associated with a certain module 62 (ie each module 62 being marked by an individual completeness score). It may indicate a level of completeness of the evaluation information gathered so far with regard to whether these evaluation information are sufficient to evaluate each characteristic C1, C2 associated with said modules 62 (and/or with the response tasks RT.1, RT.2, RT.k contained in said module 62).

Additionally or alternatively, it may indicate or be determined based on a level of statistical certainty and/or confidence with regard to the evaluation score ES determined for a characteristic C1, C2.

For example, the distribution of evaluation scores ES across all users determined for a certain characteristic C1, C2 may be considered and a standard deviation thereof may be computed. If this is above an acceptable threshold, it may be determined that an overall and eg average evaluation score ES for said characteristic C1, C2 has not been determined with a sufficient statistical confidence in this may be reflected by a respective (low) value of the completeness score.

Overall, the completeness score for each module and/or each characteristic may be used to determine any of the following (alone or in any combination):—What to ask a respondent, eg as the free formulation response task (preferably directed to a module with a so far insufficiently low completeness score);—What should be a next module for the current respondent (preferably a module with a so far insufficiently low completeness score);—If any further response tasks directed to a certain module should be output to a current respondent, eg in case said module is not yet marked by a sufficiently high completeness score;—If any further respondents are needed, eg should be involved and contacted for completing the online survey, for example in case at least one module has a completeness score below of an acceptable threshold.

Note that as a general aspect of this invention, which is not limited to any further details of the embodiments, the modules 62 may also be subdivided into topics. The response tasks of a module 62 may accordingly be associated with these topics (ie groups of response tasks RT.1, RT.2, RT.k may be formed which are associated with certain topics). A completeness score may then also be determined based on a respective topic-level. In case it is determined, that for a certain topic and across a large population of users a low completeness score is present, any of the above measures may be employed.

FIG. 4 is a schematic view of the model 100. Said model 100 receives several input parameters I1 . . . I3. These may represent any of the examples discussed herein and eg may be derived from a first analysis of the contents of the freely formulated response. For example, the input parameter I1 may indicate whether one or more (and/or which) predetermined keywords have been identified in said response. The input parameter I2 may indicate a generally determined negative or positive connotation of the response and the input parameter I3 may be an output of a so-called Word2Vec algorithm. These inputs may be used by the model 100, which has been previously trained based on verified training data, to compute the evaluation score ES and preferably a vector of evaluation scores for a number of predetermined characteristics of interest. Also, it may output confidence scores CS for each of the determined evaluation scores ES.

Note that the freely formulated response (eg as a text) may, additionally or alternatively, also be input as an input parameter to the model 100 as such. The model 100 may then include submodels or sub-algorithms to determine any of the more detailed input parameters I1 . . . I3 discussed above or the model may directly use each single word of the freely formulated response as a single input parameter (eg an input vector may be determined indicating these words from a predetermined list of words (eg dictionary) that are contained in the response). Again, based on the previous training with verified training data, the model 100 may then determine evaluation scores associated with certain words and/or combinations of words occurring within one freely formulated response RTF.

Note that an adjusted set of response tasks RT.1, RT.2, RT.k may entail that the contents of the module 62 is respectively adjusted, ie that certain response tasks RT.1, RT.2, RT.k are deleted therefrom.

After a user has completed answering a module 62, it may be determined by a dialogue-algorithm which module 62 should be covered next. Additionally or alternatively, it may be determined which response task RT.1, RT.2, RT.k or which topic of a module 62 should be covered next. Again, only those response tasks RT.1, RT.2, RT.k comprised by the adjusted set may be considered in this context.

The dialogue algorithm may be run on the server 12 or central computer device 21 or on any of the user bound devices 20.1-20.k. As a basis for its decisions, a completeness score or a confidence score as discussed above and/or a variability any of the scores determined so far may be considered. Additionally or alternatively, a logical sequence may be prestored according to which the module 62, topics or response tasks RT.1, RT.2, RT.k should be output. Generally speaking, decision rules may be encompassed by the dialogue algorithm.

Providing the dialogue algorithm helps to improve the quality of responses since users may be faced with sequences of related response tasks RT.1, RT.2, RT.k and topics. This helps to prevent distractions or a lowering of the motivation which could occur in reaction to random jumps between response tasks RT.1, RT.2, RT.k and topics. Also, this helps to increase the level of automation as well as speeds up the whole process, thereby limiting occupation time and resource usage of the computer network 10.

The features as described in the above description, claims and figures can be relevant individually or in any combination to realise the various embodiments of the invention.

1. A method of querying respondents of one or more population(s) of potential respondents with regard to one or more construct(s), with an interrogator that is configured to transmit question signals to any respondent, and to receive answer signals from the respondents in response to the questions signals, the method comprising one or more surveys, and each survey comprising at least one twisit of a querying cycle comprising the following steps running concurrently:
(a) A question selection step in which the interrogator selects one or more question(s) for each of one or more respondent(s) to be interrogated in the twisit, each question being assigned at least one of the plurality of constructs
(b) An interrogation step in which the interrogator sends question signal(s) comprising the question(s) to the one or more respondent(s), and
(c) A response step in which the interrogator receives answer signal(s) from those respondent(s) that are responsive to the interrogator's question signal(s);
wherein in at least one of the surveys in at least one of the survey's twisits, at least part the respondent(s) are queried at least twice in the same twisit in that after the interrogator, in step (c), has received answer signal(s) from a respondent of the part of the respondent(s), the interrogator, in concurrent step (a), selects one or more new question(s) for the same respondent, and in concurrent step (b), the interrogator sends question signal(s) comprising the new question(s) to the same respondent.

2. The method of claim 1, wherein if a recipient that has been queried before is queried again in the same twisit, the interrogator in the selection of the one or more question(s) for the respondent uses information about the answer signal(s) which the interrogator has received previously from the same respondent in the same twisit.

3. The method of claim 1, wherein in the same twisit, the interrogator continues querying a respondent until a respondent stop condition has been met, and a respondent stop condition is that a query load information of the respondent has reach a first threshold.

4. The method of claim 1, wherein the constructs are organised hierarchically in a way that some of the constructs are subordinate to other constructs, the interrogator in the selection of the one or more questions in the selection step
selects one or more construct(s) and then
selects one or more question(s) from only those questions that are assigned to the selected construct or to a construct that is subordinate or indirectly subordinate to the selected construct.

5. The method of claim 4, wherein some of the constructs are classified as primary constructs, wherein in the question selection step only primary constructs are selected.

6. The method of claim 4, wherein in at least one of the surveys at least one twisit comprises
(d) A confidence evaluation step in which the interrogator assigns to at least one construct with regard to at least one population a confidence score that is obtained by using information from answer signal(s) which the interrogator has received previously in the same survey from the respondent, and
wherein when a respondent that has been queried before is queried again in the same twisit, the interrogator in the selection of the one or more questions for the respondent uses one or more confidence scores that are obtained by using information from answer signal(s) form the same respondent.

7. The method of claim 6, wherein, the confidence score reflects a margin of error in the value derived from the recipient answer(s) concerning the construct for which the confidence score is calculated.

8. The method of claim 6, wherein in the selection of the one or more question(s) in the selection step the interrogator selects the question(s) only from questions assigned to constructs the confidence score of which is below a first confidence threshold.

9. The method of claim 6, wherein, once the interrogator has started querying the respondent about a construct, it continues querying the respondent about this construct until one of one or more construct stop conditions are met, the construct stop condition(s) including the confidence score of the construct and all subordinate and indirectly subordinate constructs being above the confidence threshold.

10. The method of claim 1, wherein in at least one of the surveys at least one twisit comprises
(e) A relevance evaluation step in which the interrogator assigns to at least one question with regard to at least one construct a relevance score that is obtained by using information from answer signal(s) which the interrogator has received previously, and
wherein the interrogator in the selection of the one or more questions uses one or more of the relevance scores.

11. The method of claim 10, wherein the interrogator in the selection of the one or more questions in the selection step
selects one or more constructs and then
selects one or more question from all questions or a subset of all questions based on the questions' relevance scores with regard to the construct.

12. The method of claim 11, wherein in selecting a question from all questions or a subset of all questions based on the questions' relevance scores, the likelihood that the interrogator selects a question is the higher, the higher the question's relevance score with regard to this construct is.

13. The method of claim 1, wherein in at least one of the surveys in the selection step of at least one twisit, the subset selected by the interrogator comprises only respondents from which the interrogator has not received any answer signal in other twisits of the same survey.

14. An interrogator configured to transmit question signals with regard to one or more constructs to any respondent selected from a population of potential respondents, and to receive answer signals from the respondents in response to the questions signals, the interrogator being configured to perform the querying method according to claim 1.

15. The interrogator of claim 14, further comprising:
a bus;
a communications unit connected to the bus;
a first memory connected to the bus, wherein the first memory stores a set of computer useable program code; and
a processor connected to the bus, wherein the processor executes the set of computer useable program code to perform the querying method.

16. The interrogator according to claim 15, further comprising:
a second memory, wherein the second memory stores information about each of the plurality of constructs.

17. A computer program product comprising a computer readable storage medium that stores computer useable program code executable by a processor, the executable computer useable program code comprising code to perform a method according to claim 1.

18. A method for gathering evaluation information from a user with a computer network, the computer network performing the following:
receiving an initial set of predetermined response tasks, each response task including a number of predetermined response options, wherein based on the response options selected by a user, evaluation information for evaluating at least one predetermined characteristic can be determined;
outputting, via a computer device of said computer network, at least one free-formulation response task to at least one user by means of which an at least partially freely formulated response can be received from the user;
identifying, via a computer device of said computer network, evaluation information based on the freely formulated response, said evaluation information being usable for evaluating the at least one predetermined characteristic;
generating, via a computer device of said computer network, an adjusted set of response tasks based on the identified evaluation information.

19. A computer network for gathering evaluation information for at least one predetermined characteristic from at least one user, wherein the computer network has an initial set of predetermined response tasks, each response task comprising a number of predetermined response options, wherein based on the response options selected by a user, evaluation information for evaluating at least one predetermined characteristic can be determined; and wherein the computer network comprises at least one processing unit that is configured to execute any of the following software modules, stored in a data storage unit of the computer network:
a free-formulation output software module that is configured to provide at least one free-formulation response task by means of which a freely formulated response can be received from at least one user;
a free-formulation analysis software module that is configured to analyse the freely formulated response and to thereby identify evaluation information contained therein, said evaluation information being usable for evaluating the at least one predetermined characteristic; and
a response set adjusting software module that is configured generate an adjusted set of response tasks based on the evaluation information identified by the free-formulation analysis software module.

20. The method of claim 2, wherein in the same twisit, the interrogator continues querying a respondent until a respondent stop condition has been met, and a respondent stop condition is that a query load information of the respondent has reach a first threshold.
